(19) United States
(12) Patent Application Publication
(10) Pub. No.: US 2024/0196886 A1
(43) Pub. Date: Jun. 20, 2024

(54) ANTIBACTERIAL AND/OR ANTIVIRAL COATINGS

(71) Applicant: CODIKOAT LTD, Cambridgeshire (GB)

(72) Inventors: Mohammad Javad MOHSENI, Haverhill, Cambridgeshire (GB); Reza SABERI MOGHADDAM, Haverhill, Cambridgeshire (GB); Atif AZIZ, Haverhill, Cambridgeshire (GB); Payam NAHAVANDI, Haverhill, Cambridgeshire (GB)

(73) Assignee: CODIKOAT LTD, Haverhill, Cambridgeshire (GB)

(21) Appl. No.: 18/284,893

(22) PCT Filed: Mar. 28, 2022
(86) PCT No.: PCT/EP2022/058176

§ 371 Date: Sep. 29, 2023

(30) Foreign Application Priority Data
Mar. 31, 2021 (GB) 2104679.2
Dec. 23, 2021 (GB) 2118912.1

(51) Int. Cl. A01N 25/10; A01N 25/34; A01N 31/02; A01N 35/02; A01N 59/00; A01P 1/00; A41D 13/11; C09D 5/14; C09D 101/28; C09D 129/04; C09D 171/02; C09J 11/06; C09J 129/04

(52) U.S. Cl. CPC A01N 25/10; A01N 25/34; A01N 31/02; A01N 35/02; A01N 59/00; A01P 1/00; C09D 5/14; C09D 101/286; C09D 129/04; C09D 171/02; C09J 11/06; C09J 129/04; A41D 13/1192

(57) ABSTRACT

The present invention relates to antimicrobial and/or antiviral coatings, specifically a coating comprising an antimicrobial and/or antiviral agent and a polymeric carrier. Methods of manufacture of the coating, methods of coating and uses of the coating are also described.

### FIELD OF THE INVENTION

The present invention relates to an antimicrobial and/or antiviral coating, an alcohol-containing solid antimicrobial and/or antiviral agent or product comprising a sorbent having alcohol sorbed therein, articles of manufacture where a layer is applied to at least a part of at least one surface of the article of manufacture during the manufacture process, and methods of manufacturing an antimicrobial and/or antiviral coating and alcohol-containing solid product of the invention. The invention further relates to a method of depositing an antimicrobial and/or antiviral coating or alcohol-containing solid product of the invention on a surface. The invention also relates to uses of the antimicrobial and/or antiviral coating and alcohol-containing solid product described herein.

### BACKGROUND OF THE INVENTION

Germs such as viruses, bacteria and fungi can be readily transmitted from one host to another. Germs do not move themselves but rely on people, the environment, and/or medical equipment to move. Transmission can happen as a result of contact with a contaminated surface, sprays and splashes and inhalation of droplets carrying germs.

A large number of germs are harmless and even helpful to humans and animals. However, others are harmful and can cause infections. In such cases, the prevention of the spread of germs plays an important role in protecting vulnerable subjects.

Self-disinfecting surfaces can act by denaturation (inactivation) of viruses or bacteria. Whilst alcohol solutions and gels are efficient at sanitising surfaces, these products do not enable the surfaces to remain self-sanitised over time. On the other hand, current antimicrobial coating solutions which provide a stable protection over time, are inefficient and need hours of contact with germs to inactivate them. Therefore, there remains a need to provide new antiviral and antimicrobial coating solutions that can both efficiently kill microbes and viruses in a timely manner and provide a longer period of protection.

The present invention produces a fast-acting and long-lasting solution which can inactivate viruses, bacteria and fungi on a wide range of surfaces and last for long periods of time.

### SUMMARY OF THE INVENTION

Here, presented for the first time, is an antimicrobial and/or antiviral coating comprising: i) at least one non-biological antimicrobial and/or antiviral agent; and ii) a polymer carrier. For the avoidance of doubt, the term “antimicrobial” encompasses bacteria and fungi.

In an embodiment, the at least one non-biological antimicrobial and/or antiviral agent may be present in the coating in an amount of between about 0.01% and about 40% with a particular range being from about 5% to about 15%, with about 10% being a particularly suitable amount. In a particular example the at least one non-biological antimicrobial and/or antiviral agent may be present in the coating in an amount of between about 0.1% and about 20%, or up to about 35%, For example, a concentration of between 0.01% to 3% has been found to be particularly suitable for a coating comprising HOCl as an active agent, while a concentration of up to about 0.7% has been found to be suitable where glutaraldehyde is the active agent. In another example, the agent may be present in the coating in an amount of between, about 25% and about 40%. Amounts of about 10% or about 35% have been found to be particularly suitable for a coating containing powdered alcohol as the active agent.

In an embodiment, the at least one non-biological antimicrobial and/or antiviral agent may be selected from: a disinfectant, a cleaning and/or sanitising agent a bleach, an alcohol, an oxidant, a weak acid, or a bactericidal agent and combinations thereof. Examples of suitable agents include: an alcohol, electrolysed water, hypochlorous acid (HOCl), a metal oxide, a poloxamer, a quaternary ammonium salt, fluoride ions, chitosan, poly(hexamethylene guanidine) (PHMG), carnosol, alpha-tocopherol, glutaraldehyde (GA), hyaluronic acid, citric acid, acetic acid, and combinations thereof. Other suitable agents include dodecylbenzenesulfonic acid, L-lactic acid, hydrogen peroxide, octanoic acid, peroxyacetic acid (peracetic acid), potassium peroxymonosulfate, sodium chloride, sodium chlorite, sodium hypochlorite, sodium carbonate, sodium dichloroisocyanurate dihydrate, metals such as silver ion, copper ion, iron ion, gold ion. aluminium ion, zinc ion, titanium ion, tetra acetyl ethylenediamine, and/or thymol.

The term “non-biological” is used with its standard meaning being not involving or derived from biology or living organisms and not relating to, marked by, or derived from life and living processes.

Where an alcohol is the or an active agent, it is preferable that the alcohol does not contain any water, i.e. the alcohol is anhydrous alcohol. The alcohol may be selected from methanol, ethanol, butanol. isopropanol, or tert-butanol. In an embodiment, the alcohol has a molecular weight of less than 500 g/mol. preferably less than 200 g/mol, more preferably less than 100 g/mol. Preferably, the alcohol is ethanol or butanol. Preferably, the alcohol is absolute ethanol or has an alcohol concentration of 100%.

In a particular embodiment, where alcohol is the or an active agent, the alcohol may be co-formulated with a sorbent as a solid formulation containing between about 1% and about 10% alcohol. Preferably the alcohol content of the formulation is between about 6% and about 8%. The alcohol content of the formulation may also be at least 2%, at least 2.5%, or at least 4% of the co-formulation. Expressed in another way, weight ratio of sorbent to alcohol may be in the range of 99:1 to 90:10. Particularly suitable ranges include 97.5:2.5 to 96:4. and 94:6 to 92:8. Such a co-formulation has been shown to have particularly high stability in retaining its alcohol content. Moreover, this co-formulation has and retains a high alcohol content. Furthermore, the process of the invention allows uniform deposition of a layer of solid product.

In an embodiment of the alcohol co-formulation, the sorbent may be selected from a carbohydrate, a modified carbohydrate, a polymer, a cyclic oligosaccharide, a metal-organic framework, gelatin, and/or starch. Examples of suitable sorbents include a carbohydrate, preferably a cyclic oligosaccharide, more preferably a dextrin selected from alpha-cyclodextrin, beta-cyclodextrin, gamma-cyclodextrin, and Captisol® (Ligand's modified beta-cyclodextrin technology), or a salt thereof.

In an embodiment the alcohol co-formulation is flowable, preferably in a powdered form. In such an embodiment, the alcohol co-formulation may further comprise one or more additives, including a natural salt such as rock salt, CaCl₂ or talc.

In a particular embodiment, the at least one non-biological antimicrobial and/or antiviral agent is hypochlorous acid, optionally in the form of electrolysed water. Hypochlorous acid (HOCl or HClO) is a weak acid that forms when chlorine dissolves in water and itself partially dissociates, forming hypochlorite, ClO⁻. HClO and ClO⁻ are oxidisers, and the primary disinfection agents of chlorine solutions.

It will be appreciated that the coating of the present invention may comprise a single antimicrobial and/or antiviral agent or may comprise two or more antimicrobial and/or antiviral agents. For example, the coating may comprise both an alcohol (in the form of a powdered alcohol (PA) formulation) and hypochlorous acid as antimicrobial and/or antiviral agents. In another example, the coating may comprise an alcohol (in the form of a powdered alcohol (PA) formulation), hyaluronic acid (HA) and cetylpyridinium chloride (CPC) as antimicrobial and/or antiviral agents. In a yet further example, the coating may comprise glutaraldehyde (GA) and/or HOCl as the antimicrobial and/or antiviral agent(s).

The coating of the present invention comprises a polymer carrier. Such a carrier provides a particularly suitable base that fixes or stabilises the antimicrobial and/or antiviral agent. For example, an agent that is very watery may be difficult to apply as a coating because it runs off a surface easily and quickly or is absorbed. Where alcohol is used as the antimicrobial and/or antiviral agent, the alcohol evaporates as the coating dries and so the coating retains minimal antimicrobial and/or antiviral properties. In contrast, a polymeric fixing or stabilising agent reduces or minimises such run-off and/or absorption and “fixes” or holds the active agent within the coating. As a result, a polymer carrier also contributes to the length of time for which an antimicrobial and/or antiviral agent remains active and/or retains its antimicrobial and/or antiviral properties.

In an embodiment, the polymer carrier may be present in the coating in an amount of between about 0.1% and about 20%. One particularly suitable range is between about 8% and about 20%. Another particularly suitable range is between about 0.5% and about 10%, or between 0.5% and about 5%.

In a particular embodiment, the polymer carrier may be a water-based, water-soluble polymer, optionally a biodegradable water-based polymer. Such carriers have particular application for coatings to surfaces for which repeated application of an antimicrobial and/or antiviral coating is required, or where the surface may be single use. It will be appreciated that the term “surface” encompasses an internal, as well as an external, surface.

Examples of such carriers include Poly(ethylene glycol) (PEG), polyethylene oxide (PEO), Polyvinyl pyrrolidone (PVP), Polyvinyl alcohol (PVA), Polyacrylic acid (PAA), Polyacrylamides. N-(2-Hydroxypropyl) methacrylamide (HPMA), poly Divinyl Ether-Maleic Anhydride. Polyoxazolines. Polyphosphates, Polyphosphazenes, Xanthan Gum, Pectin, Chitosan, Dextran, Carrageenan, Guar Gum, Hydroxypropylmethyl cellulose (HPMC), Hydroxypropyl cellulose (HPC), Hydroxyethyl cellulose (HEC), Sodium carboxy methyl cellulose (Na-CMC), Hyaluronic acid (HA), Albumin, Starch, gum arabic, dextrin glue, glycerol, and combinations thereof.

The carrier may have the properties of or be combined with a plasticizer. For some applications, it is necessary or desirable to add some plasticity, pliability and/or flexibility to reduce or minimise the rigidity and brittleness of the coating. Examples of suitable plasticisers include glycerol, sorbitol, sucrose, dibutyl phthalate, ethylene glycol, diethylene glycol, tri ethylene glycol, tetra ethylene glycol, polyethylene glycol, oleic acid, citric acid, tartaric acid, malic acid, Soybean oil, Dodecanol, lauric acid, tributyrin, trilaurin, cpoxidized soybean oil, mannitol, diethanolamine. Fatty acids, triethyl citrate, sucrose esters, and combinations thereof.

In use, the coating includes no protection or additional layers to protect the coating from external factors, such as water. As a result, high coating stability is desired to provide a coating that is stronger and able to withstand more touch forces that (more rapidly) remove the coating. One way to improve the longevity and stability of the coating maybe to use a higher molecular weight polymer. For example, PVA having a molecular weight of 130 kDa is less soluble compared to 2 kDa PVA.

Another or additional way to reduce the water-solubility of a matrix, such as that created by PVA, and hence propensity for the active agent to leach from the coating, is to cross-link the polymers.

In another embodiment, the polymer carrier may be water insoluble or is a solvent-based polymer. Examples of such carriers are derivatives of cellulose including ethyl cellulose, methyl cellulose, cellulose acetate and cellulose acetate butyrate, poly(methyl methacrylate) (PMMA), poly (2-phenyl-2-oxazoline) (PPhOx), polyethylene oxide (PEO), poly(2-hydroxyethyl methacrylate), poly (1,2butylene glycol) (PBG), polyacrylonitrile, polyvinyl chloride, polyvinylidene fluoride and combinations thereof. Such carriers have particular application for coatings to surfaces for which only a single application of an antimicrobial and/or antiviral coating is required or possible, or where the surface has minimal wear and tear and/or is for multiple use. Such a coating may also be appropriate for surfaces in which leaching or dissolving of the active agent when in contact with water is undesirable, for example disposable gloves. It will be appreciated that the term “surface” encompasses an internal, as well as an external, surface.

In another embodiment, the polymer carrier may (additionally) have adhesive properties. The term “adhesive” refers to a substance that is capable of holding materials together in a functional manner by surface attachment that resists separation. “Adhesive” as a general term includes cement, mucilage, glue, and paste—terms that are often used interchangeably for any organic material that forms an adhesive bond. An alternative definition for “adhesive” is ‘sticky’. Adhesive properties allow or increase retention of the coating of the invention on a surface.

In yet another embodiment, the coating as defined herein may further include a plasticiser. Alternatively or in addition, the polymer carrier may be a plasticiser or has properties of a plasticiser. It will be appreciated that a plasticiser is a substance added to a formulation to produce or promote plasticity and flexibility and to reduce brittleness. An example of a suitable plasticiser is glycerol.

In a particular embodiment, the coating may be formulated as nanofibres. A coating comprising nanofibres is also contemplated. Such a formulation has particular application to fabrics, such as facemasks or air filters such as those used in HVAC systems, where breathability of the fabric is required. Such nanofibres may be formed by any suitable method, such as and including electrospinning.

In another embodiment, the coating may be formulated as a spray, dip or as a paint. For example, a coating for repeated application may be more appropriately formulated as a spray having a low viscosity. In contrast, a coating for the surface of furniture may be more appropriately formulated as a paint having a high viscosity. However, for some applications, a viscosity that allows the coating to be sprayed or dipped may be appropriate for coating nitrile gloves, for example.

It will be appreciated that the coating may be formulated as a spray, dip or paint and/or include nanofibres.

In use, the coating is preferably active in the form in which it is applied to a surface. For example, no additional agent, such as water, is required to release or activate the active agent.

In a further embodiment the coating may further include a neutral, pleasant, or unpleasant fragrance and/or flavouring. This is to mask the smell of alcohol, polymers and/or components, including active ingredients in the formulation and to discourage ingestion of the product or licking of the coating. The coating/may additionally or alternatively further include a colourant to enable an article carrying a coating of the present invention to be readily identified by visual means.

In a yet further embodiment, the coating may further include additional components, active ingredients. additives, plasticisers, carriers, stabilisers and/or fillers, examples of which include nitrile, calcium carbonate, calcium nitrate tetrahydrate, calcium chloride, glycerol, water, one or more solvent, and combinations and mixtures thereof.

In a specific example, the coating may comprise about 15% ethyl cellulose and 500-7000 ppm HOCl, optionally further including about 10% powdered alcohol as defined and described herein. In another specific example, the coating may comprise about 8% PVA and 500-7000 ppm HOCl, optionally further including about 10% powdered alcohol as defined and described herein. In a further specific example, the coating may comprise about 1% ethyl cellulose, about 0.1% glycerol and about 10,000 ppm HOCl. The polymer range may be in a range of between about 0.1% and about 20% and the HOCl concentration may be in a range of from about 200 ppm to about 100,000 ppm. A particular example has about 1% (10,000 ppm) HOCl. Optionally, in both or either example, the formulation may include, comprise or consist of nanofibres.

In another specific embodiment, the active agent in the coating may be glutaraldehyde (GA), preferable at a concentration of about 2% or less, for example 0.9% or less than 0.7%.

In another aspect the present invention resides in the use of a coating as described and defined herein to impart antimicrobial and/or antiviral properties to a surface. Expressed in another way, the present invention resides in a method for imparting antimicrobial and/or antiviral properties to a surface, the method comprising applying a coating as defined and described herein to the surface.

While the coating may be applied to any surface, particular application is for a facemask, a medical fabric such as a surgical gown, a (surgical, non-surgical, re-usable, disposable) glove, a wound dressing, a mobile telephone or device, a touchscreen, a keypad, a keyboard, a button, a handle, a screen protector, food packaging, a piece of furniture such as a seat, a toilet seat, a cup, a worktop, and an appliance, such as a kitchen appliance, a door plate, a water tap, a bank note, a filter, one or more component parts for air ventilation systems, air filters such as those for heating, ventilation, and air conditioning (HVAC) systems, and a car steering wheel. It will also be appreciated that the surface may be of any material, including fabric, wood, glass, ceramic, plastic, elastic, polymeric, natural, synthetic and mixtures and combinations thereof. As a specific example, the surface may be a glove, such as a rubber or fabric glove. Disposable and/or rubber gloves are typically made from nitrile, latex, vinyl and blends and mixtures thereof. In a specific case, nitrile gloves are made from nitrile butadiene rubber (NBR), which is a synthetic material made by combining monomers such as butadiene and acrylonitrile. Non-disposable gloves are typically made from fabric such as cotton, nylon or rubber based.

In an embodiment, the coating may be applied in one or more layers, each layer having a thickness in a range of between about 1 micron to about 1000 microns, preferably between about 1 micron to about 500 microns, preferably about 5 microns to about 200 microns, preferably about 15 to about 100 microns, more preferably about 20 to about 50 microns, or about 5 to 10 microns, or up to about 200 microns. In particular situations, a coating of up to 10 mm is also desired and appropriate. It will be appreciated that coating thickness may be of any discrete thickness or range within the ranges provided herein. For example, a layer may be about 7.8 microns thick, or it may be between about 8.6 and 10.1 microns thick.

In a particular embodiment, the layers may comprise more than one constituent that may be applied together in a single coating or sequentially to constitute a single, complete layer. For example, a carrier may be sprayed onto a surface before an antimicrobial and/or antiviral agent but the two components are considered, once applied, to constitute a single layer. Further layers may then be similarly applied.

In a particular embodiment the coating may be continuous. Alternatively, the coating may be discontinuous. or a combination of continuous and discontinuous. For example, the coating may be micro-needled in part to impart breathability to all or part of the coating.

In another embodiment, the coating may be applied by painting, spraying, dipping or flow-coating. Painting encompasses brushing and rolling.

In a further embodiment, the coating is for use in the inactivation of a germ, virus, microbe, bacteria, or fungus. Expressed in another way, there is provided a method for inactivating a germ, virus, microbe, bacteria, or fungus, the method comprising the application of a coating as defined and described herein.

Where the germ is a virus, the virus may be enveloped or non-enveloped. In a particular embodiment, the virus may be a coronavirus such as Sars-CoV-1, Sars-CoV-2, a flu virus, HPV, HIV, or norovirus.

In another aspect, the present invention relates to an antimicrobial and/or antiviral alcohol-containing solid product comprising a sorbing substance (sorbent) having alcohol sorbed therein or thereto, wherein the solid product contains between about 2% and about 10% alcohol, for example between about 6% to about 8% alcohol. In another example, the solid product contains more than 2% alcohol, preferably at least 2.5% alcohol, more preferably at least 4% alcohol. In another embodiment, the solid product contains between about 6% and about 8% alcohol. In an embodiment, the antimicrobial and/or antiviral alcohol-containing solid product consists of a sorbent having alcohol sorbed therein, wherein the solid product contains more than 2% alcohol. In an embodiment, the solid product contains at least 2.5% alcohol, more preferably at least 4% alcohol. In another embodiment, the solid product contains between about 6% and about 8% alcohol. In an embodiment, the alcohol content in the solid product remains above 2% after 7 days of storage at a temperature between 15 and 35° C. In an embodiment, the alcohol content in the solid product remains above 2% after 14 days of storage at a temperature between 15 and 35° C. In an embodiment, the alcohol content in the solid product remains above 2% after 30 days of storage at a temperature between 15 and 35° C.

In an embodiment, the sorbent may be an absorbing and/or adsorbing substance. In an embodiment, the sorbent may be an absorbing substance. In an embodiment, the sorbent may be an adsorbing substance. In an embodiment, the sorbent may be an absorbing and adsorbing substance. The sorbent may form hydrogen bonds with alcohol. The sorbent may be capable of encapsulating alcohol molecule in its structure. Cyclodextrins are well suited to encapsulate alcohol molecules because of their cyclic structure. In an embodiment, the sorbent may be selected from a carbohydrate, a modified carbohydrate, a polymer, a metal-organic framework, gelatin, and/or starch. In an embodiment, the sorbent may be a carbohydrate. In an embodiment, the carbohydrate is dextran or a dextrin. In an embodiment, the carbohydrate is dextran. Preferably the sorbent may be a dextrin selected from alpha-cyclodextrin, beta-cyclodextrin, gamma-cyclodextrin, and Captisol® (Ligand's modified beta-cyclodextrin technology), or a salt thereof. More preferably, the dextrin is gamma-cyclodextrin. Captisol® (Ligand's modified beta-cyclodextrin technology) may be able to provide enhanced encapsulation of alcohols as well as provide more stable alcohol-containing solid product.

The structures of alpha-cyclodextrin, beta-cyclodextrin, gamma-cyclodextrin are shown below:

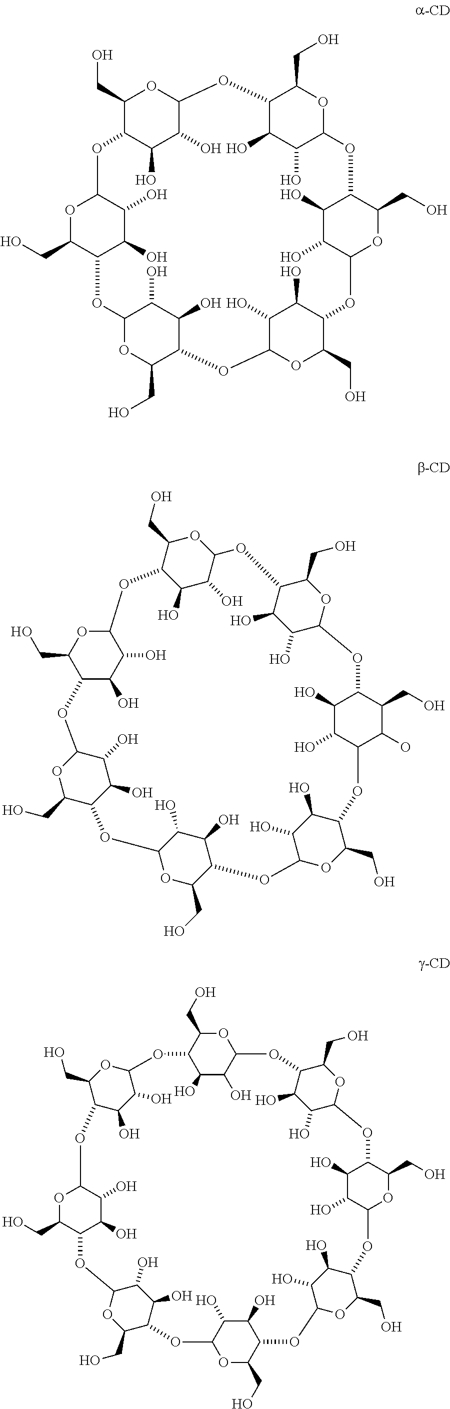

In an embodiment, the sorbent is a metal-organic framework, preferably a porphyrin-based metal-organic framework or a porphyrin derivative-based metal-organic framework.

It is preferable that the alcohol does not contain any water. In an embodiment, the alcohol is anhydrous alcohol. In an embodiment, the alcohol has a concentration of alcohol of 100%. In an embodiment, the alcohol is selected from methanol, ethanol, butanol, isopropanol, or tert-butanol. In an embodiment, the alcohol has a molecular weight of less than 500 g/mol, preferably less than 200 g/mol, more preferably less than 100 g/mol. Preferably, the alcohol is ethanol. Preferably, the alcohol is absolute ethanol.

In an embodiment, the weight ratio of sorbent to alcohol may be in the range of 99:1 to 90:10. Preferably, the weight ratio of sorbing substance to alcohol is in the range of 97.5:2.5 to 94:6.

In an embodiment, the antimicrobial and/or antiviral alcohol-containing solid product further comprises an additive, optionally a natural salt such as rock salt, CaCl₂ or talc.

In an embodiment, the alcohol-containing solid product is dry to touch. In an embodiment, the alcohol-containing solid product is flowable, for example in the form of a powder. Expressed in another way, the antimicrobial and/or antiviral alcohol-containing solid product is an antimicrobial and/or antiviral alcohol-containing powder.

The present invention also relates to an antibacterial and/or antiviral alcohol-containing powder comprising or consisting of a sorbing substance having alcohol sorbed therein, wherein the sorbing substance is gamma-cyclodextrin, wherein the alcohol is ethanol, and wherein the weight ratio of sorbing substance to alcohol is 99:1 to 90:10, preferably in the range of 97.5:2.5 to 94:6. The present invention also relates to an antibacterial and/or antiviral alcohol-containing powder consisting of a sorbing substance having alcohol sorbed therein, wherein the sorbing substance is gamma-cyclodextrin, wherein the alcohol is ethanol, and wherein the weight ratio of sorbing substance to alcohol is 99:1 to 90:10, preferably in the range of 97.5:2.5 to 94:6.

The alcohol-containing solid product as defined herein, or the alcohol-containing powder as defined herein. can be used on a wide variety of surfaces to give them antibacterial and/or antimicrobial properties. The surfaces may be selected from fabrics, plastics, polymers (natural or synthetic), or metals.

The present invention also relates to an article of manufacture wherein a layer comprising the alcohol-containing solid product as defined herein, or the alcohol-containing powder as defined herein is applied to at least a part of at least one surface of the article of manufacture. In an embodiment, the layer is applied on an adhesive. In an embodiment, the layer comprises the alcohol-containing solid product as defined herein. In an embodiment, the layer comprises the alcohol-containing powder as defined herein. In an embodiment, the layer is uniform. In an embodiment, the thickness of the layer comprising the alcohol-containing solid product as defined herein, or the alcohol-containing powder as defined herein, is in the range of 1 micron to 500 microns, preferably in the range of 20 to 40 microns. In an embodiment, the thickness of the adhesive layer is in the range of 100 nm to 500 microns. Preferably, the thickness of the adhesive layer is in the range of 1 to 50 microns, more preferably in the range of 1 to 10 microns. Preferably, the thickness of the adhesive layer is in the range of 3 to 7 microns.

At least one coating may be on an outer surface of the article of manufacture. Alternatively, the coating may be on an inner surface of the article of manufacture, such that the coating is comprised within the article of manufacture. In an embodiment, the coating may be on both the inner surface and the outer surface of the article of manufacture. In an embodiment, the layer is applied on an adhesive.

In an embodiment, the article of manufacture is selected from a facemask, a medical fabric such as a surgical gown, a (surgical, non-surgical, re-usable, disposable) glove, latex, a mobile telephone or device, a touchscreen, a keypad, a keyboard, a button, a handle, a screen protector, food packaging, a piece of furniture such as a seat, a toilet seat, a cup, a worktop, and an appliance, such as a kitchen appliance, a door plate, a water tap, a bank note, a filter, component parts for air ventilation systems, air filters such as those for heating, ventilation, and air conditioning (HVAC) systems as well as high-efficiency particulate absorbing (HEPA) filters and high-efficiency particulate arrestance filters, and a car steering wheel. Preferably, the article of manufacture is selected from a facemask, a surgical gown, a glove, or a filter. In an embodiment, the article of manufacture is a textile used in the medical, healthcare, fitness, or leisure industry, education and/or scientific establishments.

The present invention also relates to a textile wherein a layer comprising the coating and/or alcohol-containing solid product, or the alcohol-containing powder as defined herein, is applied to at least a part of at least one surface of the textile. In an embodiment, the layer comprises the coating and/or alcohol-containing solid product as defined herein. In an embodiment, the layer comprises the alcohol-containing powder as defined herein. In an embodiment, the layer is uniform. In an embodiment, both sides of a textile are coated with a layer comprising the coating, the alcohol-containing solid product, and/or the alcohol-containing powder as defined herein.

The present invention also relates to an antimicrobial and/or antiviral paper or metal wherein a layer comprising the coating and/or alcohol-containing solid product, and/or the alcohol-containing powder as defined herein is applied to at least a part of at least one surface of the paper or metal. In an embodiment, the layer comprises the coating and/or alcohol-containing solid product as defined herein. In an embodiment, the layer comprises the coating and/or alcohol-containing powder as defined herein. In an embodiment, the layer is uniform. In an embodiment, the paper is an adhesive paper, preferably an adhesive micropore paper. In an embodiment, the layer is applied to at least a part of at least one adhesive surface of the paper. In an embodiment, both sides of the adhesive paper are coated with the coating, the alcohol-containing solid product, and/or the alcohol-containing powder as defined herein.

The present invention also relates to an antimicrobial and/or antiviral polymer or plastic wherein a layer comprising the coating and/or alcohol-containing solid product, and/or the alcohol-containing powder as defined herein is applied to at least a part of at least one surface of the polymer or plastic. In an embodiment, the layer comprises the coating and/or alcohol-containing solid product as defined herein. In an embodiment, the layer comprises the alcohol-containing powder as defined herein. In an embodiment, the layer is uniform. The polymer may be a natural polymer such as latex, or synthetic such as neoprene. In an alternative, the coating and/or alcohol-containing solid product, and/or the alcohol-containing powder as defined herein is integrated into the plastic before moulding to enable the plastic to be moulded into different shapes

The present invention also relates to the article of manufacture as defined herein, the textile as defined herein, the antimicrobial and/or antiviral paper or metal as defined herein, or the antimicrobial and/or antiviral polymer or plastic as defined herein, wherein the layer consists of a single coating of the coating and/or alcohol-containing solid product as defined herein, and/or the alcohol-containing powder as defined herein, and wherein the thickness of the layer is in the range of 1 to 500 microns, preferably 5 to 200 microns, preferably 15 to 100 microns, more preferably 20 to 50 microns, optionally 5 to 20 microns.

The present invention also relates to the article of manufacture as defined herein, the textile as defined herein, the antibacterial and/or antiviral paper or metal as defined herein, or the antibacterial and/or antiviral polymer or plastic as defined herein, wherein the layer consists of one or more coating of the coating as defined herein and/or alcohol-containing solid product as defined herein, or the alcohol-containing powder as defined herein, and wherein the thickness of the layer is in the range of 1 to 500 microns, preferably 5 to 200 microns, preferably 10 to 200 microns, preferably 15 to 100 microns, more preferably 20 to 50 microns, optionally 5 to 20 microns. In an embodiment, the thickness of the layer is in the range of 20 to 50 microns, or 5 to 20 microns. In a specific example, the thickness of the layer may be up to or about 10 mm.

In an embodiment, each coating consists of up to 10 mg of coating and/or alcohol-containing solid product, and/or alcohol-containing powder as defined herein, per square centimetre of surface to coat. In an embodiment, each coating consists of up to 5 mg of coating and/or alcohol-containing solid product, and/or alcohol-containing powder as defined herein, per square centimetre of surface to coat. In an embodiment, each coating consists of 4.4 mg of coating and/or alcohol-containing solid product, and/or alcohol-containing powder as defined herein, per square centimetre of surface to coat. In an embodiment, each coating consists of up to 3 mg of coating and/or alcohol-containing solid product, and/or alcohol-containing powder as defined herein, per square centimetre of surface to coat. In an embodiment, each coating consists of up to 2 mg of coating and/or alcohol-containing solid product, and/or alcohol-containing powder as defined herein, per square centimetre of surface to coat. In an embodiment, the layer comprises the coating and/or alcohol-containing solid product as defined herein. In an embodiment, the layer comprises the alcohol-containing powder as defined herein.

The present invention also relates to a fabric, such as a facemask, (surgical, non-surgical, disposable) gloves, wound dressings, a filter such as an air filter for heating, ventilation, and air conditioning (HVAC), plastic packaging, the fabric comprising the antimicrobial and/or antiviral paper, textile or plastic as defined herein. In an embodiment, the fabric comprises a splash resistant non-woven fabric, the antimicrobial and/or antiviral paper, textile or plastic as defined herein, a high-density filter layer, and a direct contact skin layer. In an embodiment, the fabric is a type 2 R (IIR) facemask further comprising the antimicrobial and/or antiviral textile as defined herein. In an embodiment, the facemask is an antiviral N95 facemask further comprising the antimicrobial and/or antiviral textile as defined herein.

In an embodiment, the facemask is a type 3 R (IIIR) facemask, wherein a layer of the coating and/or alcohol-containing solid product, and/or the alcohol-containing powder as defined herein, is added to the existing 3 layers of a type 2 R (IIR) facemask. A IIR facemask is composed of three layers:
1. Splash resistant non-woven fabric
2. High density filter layer
3. Direct contact skin layer

The coating and/or alcohol-containing solid product and/or alcohol-containing powder can be sprayed on the high-density filter layer itself.

Alternatively, to add the coating and/or alcohol-containing solid product and/or alcohol-containing powder to a facemask, an extra layer is added after the splash resistant fabric. This layer is a microporous fabric composed of paper. The microporous fabric ensures that the breathability of the facemask is not compromised. Current facemasks have pore sizes in the range 0.1-0.3 μm (N95), and 0.3-10 μm (standard surgical mask). The addition of a layer of powdered alcohol to a type 2 R (IIR) facemask results in the following structure:
1. Splash resistant non-woven fabric
2. Antimicrobial and/or antiviral adhesive paper (e.g. 3M micropore tape coated with a layer of the alcohol-containing solid product as defined herein, or the alcohol-containing powder as defined herein)
3. High density filter layer
4. Direct contact skin layer

In an embodiment, the ends of the antimicrobial and/or antiviral adhesive paper are sutured to the other layers. In an embodiment, the inner side of the antimicrobial and/or antiviral adhesive paper is coated with the coating, alcohol-containing solid product, and/or the alcohol-containing powder as defined herein. In another embodiment, where the wearer is to be protected (e.g. IIR facemask), the outer side of the antimicrobial and/or antiviral adhesive paper is coated with the coating, alcohol-containing solid product, and/or the alcohol-containing powder as defined herein. In an embodiment, both sides of the antimicrobial and/or antiviral adhesive paper are coated with the coating, alcohol-containing solid product, and/or the alcohol-containing powder as defined herein.

An advantage of having the antimicrobial and/or antiviral adhesive paper is that it makes a stronger bond with the coating, alcohol-containing solid product, and/or the alcohol-containing powder as defined herein, due to the adhesive nature of the paper.

In applications such as facemasks and filters where breathability of the final product is of great importance, the coated surface can be punched with appropriately sized needle arrays to create appropriately sized holes in the surface for improved breathability. In an embodiment, 1 μm-500 μm range microneedle arrays are used. 1 μm-500 μm range microneedle arrays are suitable to punch standard surgical facemasks such as the IIR facemask where the pore size of the typical facemask is 0.3 μm -10 μm. Punching can be performed after the coating has been applied. Alternatively, punching microneedle arrays can be used as ‘masks’ or template during the coating process.

For products requiring smaller pores, such as the N95 facemasks and filters where pores are typically 0.1 -0.3 μm. nanoneedle arrays can be used. Alternatively, an extra fabric layer such as an antimicrobial and/or antiviral adhesive paper (e.g. the micropore tape) can be used. Even if the micropore tape is punched, the general integrity of the facemask is not compromised because the existing layers are intact and not affected in any way.

It will be appreciated that it is preferable if the coating/solid product is not designed for consumption or is non-ingestible. In this respect, the product may include flavour and/or fragrance that is either neutral or unpleasant to dissuade ingestion. The coating/solid product may additionally or alternatively include a colourant to enable an article carrying a coating of the present invention to be readily identified by visual means.

The present inventors have developed a new method of producing an alcohol-containing solid product which considerably reduces the synthesis time. This method involves directly mixing an alcohol and a sorbing substance (e.g. cyclodextrin) as opposed to diffusing an alcohol into a sorbing substance (e.g. cyclodextrin). The product obtained is then dried by a vacuum oven to produce the desired alcohol-containing solid product (e.g. powdered alcohol). In this method, alcohol is encapsulated in a sorbing substance (e.g. cyclodextrin). Therefore, in the case of cyclodextrins, the larger the diameter of the cyclodextrin ring the more alcohol will be encapsulated. This method does not rely on dissolving the sorbing substance, and therefore the method is best carried out in the absence of water. This new faster method is incredibly beneficial for upscaling and manufacturing at a large scale. Surprisingly, this new method required a significantly lower volume of ethanol thus resulting in a higher production efficiency.

The present invention further relates to a method of preparing an antimicrobial and/or antiviral alcohol-containing solid product comprising the steps of: a) directly mixing a liquid alcohol with a sorbing substance (sorbent), and b) drying the mixture obtained to form the alcohol-containing solid product. It is preferred that the present method is carried out in the absence of water. In an embodiment, the alcohol-containing solid product is an alcohol-containing powder. In an embodiment, the alcohol-containing powder is dry to touch. In an embodiment, the alcohol-containing solid product is flowable.

In an embodiment, step a) is carried out at a temperature in the range of 10 to 50° C. In an embodiment, step a) is carried out at a temperature in the range of 10 to 30° C. In an embodiment, step a) is carried out at a temperature in the range of 16 to 18° C. In an embodiment, step a) is carried out for 5 to 60 minutes. In an embodiment, step a) is carried out for 5 to 20 minutes. Preferably, step a) is carried out for 10 minutes.

In an embodiment, step b) is carried out by vacuum oven drying, freeze drying, or ambient air drying. In an embodiment, step b) is carried out by vacuum oven drying at a temperature in the range of 16 to 60° C. In an embodiment, step b) is carried out by vacuum oven drying at a temperature in the range of 16 to 40° C. In an embodiment, step b) is carried out by vacuum oven drying at a temperature in the range of 19 to 25° C. In an embodiment, step b) is carried out at a pressure in the range of −0.1 bar to −10 bar. In an embodiment, step b) is carried out at a pressure in the range of −0.5 bar to −5 bar. In an embodiment, step b) is carried out at a pressure in the range of −1 bar to −2 bar. In an embodiment, step b) is carried out for 10 minutes to 30 hours. In an embodiment, step b) is carried out for 10 minutes to 1 hour. In an embodiment, step b) is carried out by vacuum oven drying at a temperature in the range of 16 to 60° C. and at a pressure in the range of −0.1 bar to −10 bar for 10 minutes to 30 hours. In an embodiment, step b) is carried out by vacuum oven drying at a temperature in the range of 20 to 50° C. and at a pressure in the range of −0.5 bar to −2 bar for 10 minutes to 24 hours. Step b) may be carried out by vacuum oven drying at a temperature in the range of 35 to 45° C. for 15 minutes to 35 minutes, more preferably at a temperature of 40° C. for 25 minutes. Step b) may also be carried out by vacuum oven drying at a temperature in the range of 15 to 25° C. for 4 hours to 24 hours, more preferably at a temperature of 20° C. for 24 hours. In an embodiment, step b) is carried out at a temperature of 40° C. for 25 minutes. In another embodiment, step b) is carried out at a temperature of 20° C. for 24 hours.

In an embodiment, the sorbent is an absorbing and/or adsorbing substance. In an embodiment, the sorbent is an absorbing substance. In an embodiment, the sorbent is an adsorbing substance. In an embodiment, the sorbent is an absorbing and adsorbing substance. In an embodiment, the sorbent is selected from a carbohydrate, a modified carbohydrate, a polymer, a metal-organic framework, gelatin, and/or starch. In an embodiment, the sorbing substance is a carbohydrate. In an embodiment, the carbohydrate is dextran or a dextrin. In an embodiment, the carbohydrate is dextran. Preferably the carbohydrate is a dextrin selected from alpha-cyclodextrin, beta-cyclodextrin, gamma-cyclodextrin, and Captisol® (Ligand's modified beta-cyclodextrin technology), or a salt thereof. Preferably, the dextrin is gamma-cyclodextrin. In an embodiment, the sorbent is a metal-organic framework, preferably a porphyrin-based metal-organic framework or a porphyrin derivative-based metal-organic framework.

Preferably, the alcohol does not contain any water. In an embodiment, the alcohol is anhydrous alcohol. In an embodiment, the alcohol has a concentration of alcohol of 100%. In an embodiment, the alcohol is selected from methanol, ethanol, butanol, isopropanol, or tert-butanol. In an embodiment, the alcohol has a molecular weight of less than 500 g/mol, preferably less than 200 g/mol, more preferably less than 100 g/mol. Preferably, the alcohol is ethanol. Preferably, the alcohol is absolute ethanol.

In an embodiment, the weight ratio of sorbent to alcohol in step a) is 1:0.5 to 1:10. Preferably, the weight ratio of sorbing substance to alcohol is 1:1.5 to 1:2. For example. 1 g of sorbing substance (e.g. gamma-cyclodextrin) is mixed with 2 ml of anhydrous alcohol (e.g. absolute ethanol). In an embodiment, 1 g of sorbing substance (e.g. cyclodextrin) is mixed with 0.5 ml-10 ml anhydrous alcohol (e.g. absolute ethanol).

In an embodiment, the method further comprises mixing an additive with the sorbing substance prior to step a). In an embodiment, the mixing of the additive with the sorbing substance is carried out for 30 minutes to 24 hours. In an embodiment, the mixing of the additive with the sorbing substance is carried out for 6 hours. In an embodiment, the mixing of the additive with the sorbing substance is carried out at 200 rpm to 1000 rpm. In an embodiment, the mixing of the additive with the sorbing substance is carried out at 600 rpm. In an embodiment, the mixing of the additive with the sorbing substance is carried out at a temperature in the range of 17 to 90° C. In an embodiment, the mixing of the additive with the sorbing substance is carried out for 30 minutes to 24 hours, at 200 rpm to 1000 rpm, at a temperature in the range of 17 to 90° C. In an embodiment, the mixing of the additive with the sorbing substance (e.g. cyclodextrin) is carried out in water or in a solvent. In an embodiment, the mixing of the additive with the sorbing substance (e.g. cyclodextrin) is carried out in deionised water. In an embodiment, the mixing of the additive with the sorbing substance (e.g. cyclodextrin) is carried out in a solvent. In an embodiment, the additive is a natural salt such as rock salt or CaCl₂. The mixing of a natural salt such as rock salt, CaCl₂, or tale with cyclodextrin can be carried out in deionised water.

The present invention further relates to a method of depositing a layer of a coating or an alcohol-containing solid product as defined and described herein on a surface, wherein the method comprises the step of spraying a coating of the coating or alcohol-containing solid product on the surface. In an embodiment, the coating and alcohol-containing solid product may be prepared according to methods of preparation defined and described herein. In an embodiment, the alcohol-containing solid product is an alcohol-containing powder.

In an embodiment, the step of spraying a coating of the coating formulation or alcohol-containing solid product as defined and described herein on the surface is carried out at least once. Preferably, the step of spraying a coating of the coating formulation or alcohol-containing solid product on the surface is carried out two times. In an embodiment, the step of spraying a coating of the coating formulation or alcohol-containing solid product on the surface is carried out using a spray nozzle, preferably a spray gun or a spray pump. In an embodiment, the step of spraying a coating of the coating formulation or alcohol-containing solid product on the surface is carried out using an electrostatic spray gun. An electrostatic spray gun can charge the coating formulation or alcohol-containing solid product, allowing it to make a stronger bond with the surface on which it is sprayed.

In an embodiment, the thickness of the or each layer is in the range of 1 to 500 microns, preferably 5 to 200 microns, preferably 15 to 100 microns, more preferably 20 to 50 microns or 10 to 20 microns. In one embodiment, the thickness of the or each layer is around 10 mm.

The present invention also relates to a method of depositing a layer of a coating formulation or an alcohol-containing solid product on a surface as defined and described herein, wherein the method comprises the steps of: a) optionally preparing an adhesive solution, b) optionally coating the surface with the adhesive solution to form an adhesive layer, and c) coating either the surface or the optional adhesive layer applied to the surface with the coating formulation or alcohol-containing solid product. Optionally, the method further comprises punching the surface after step c), or a punching microneedle array is used as a mask during steps b) and c). In an embodiment, the coating and alcohol-containing solid product may be prepared according to methods of preparation defined herein. In an embodiment, the alcohol-containing solid product is an alcohol-containing powder.

In an embodiment, step b) is carried out using a padding machine or by spraying. In an alternative or additional embodiment, step b) is carried out by dipping and/or coating.

In an embodiment, the coating or adhesive solution comprises water and a biodegradable water-based adhesive, preferably an adhesive selected from xanthan gum, gum arabic, starch glue, and dextrin glue.

In an embodiment, step c) is carried out (i) at least once, and to obtain a layer thickness of 1 micron to 10 mm, 1 micron to 1 mm, 1 to 500 microns, preferably 5 to 200 microns, preferably 15 to 100 microns, more preferably 20 to 50 microns or 10 to 20 microns or around 10 mm, or (ii) at least twice, at least 3 times, or at least 4 times, and to obtain a layer thickness of 1 micron to 10 mm, 1 micron to 1 mm, 1 to 500 microns, preferably 10 to 200 microns, preferably 15 to 100 microns, more preferably 20 to 50 microns. In an embodiment, step c) is carried out at least once, and to obtain a layer thickness of 1 micron to 10 mm, 1 micron to 1 mm, 1 to 500 microns, preferably 10 to 200 microns, preferably 15 to 100 microns, more preferably 20 to 50 microns. In an embodiment, step c) is carried out twice, and to obtain a layer thickness of 1 micron to 10 mm, 1 micron to 1 mm, 1 to 500 microns, preferably 10 to 200 microns, preferably 15 to 100 microns, more preferably 20 to 50 microns. In an embodiment, step c) may be carried out either once, twice or multiple times to obtain a layer with a total thickness of up to 10 mm. In an embodiment, step c) is carried out using a spray nozzle, preferably a spray gun or a spray pump. In an embodiment, step c) is carried out using an electrostatic spray gun. In a yet further embodiment, step c) is carried out using dipping and/or painting (e.g. brushing, rolling).

In an embodiment, the surface is selected from a fabric or textile, a plastic, a glass, a polymer, and a metal. Where the surface is a polymer, for example for use in gloves, the polymer may be nitrile, latex, vinyl and/or mixtures thereof. Gloves may also be made from other fabrics cotton, nylon or rubber based, and may be moulded or knitted. For the avoidance of doubt, the term “nitrile” encompasses butadiene rubber (NBR) which is a synthetic material made by combining monomers such as butadiene and acrylonitrile.

In an embodiment, the coating or alcohol-containing solid product is applied to at least a part of at least one side of the surface. In an embodiment, the coating or alcohol-containing solid product is applied to at least a part of each side of the surface. In a further embodiment, the coating or alcohol-containing solid product is applied to or integrated into material from which the surface is made, before moulding and/or shaping.

The present invention further relates to the use of a sorbing substance (sorbent) to sorb an alcohol to render it suitable for deposition as an antimicrobial and/or antiviral layer on a surface. In an embodiment, the sorbent is as defined herein. In an embodiment, the alcohol is as defined herein. In an embodiment, the weight ratio of sorbent to alcohol is in the range of 99:1 to 90:10, preferably in the range of 97.5:2.5 to 94:6.

In applications such as facemasks and air filters where breathability of the final product is of great importance, the coated surface may be punched with appropriately sized needle arrays to create appropriately sized holes in the surface for improved breathability. In an embodiment, 1 μm-500 μm range microneedle arrays are used. 1 μm-500 μm range microneedle arrays are suitable to punch standard surgical facemasks such as the IIR facemask where the pore size of the typical facemask is 0.3-10 μm. Punching can be performed after the coating has been applied. Alternatively, punching microneedle arrays can be used as ‘masks’ or template during the coating process.

For products requiring smaller pores, such as the N95 facemasks where pores are typically 0.1 -0.3 μm. nanoneedle arrays can be used. Alternatively, an extra fabric layer such as an antimicrobial and/or antiviral adhesive paper (e.g. the micropore tape) should be used. Even if the micropore tape is punched, the general integrity of the facemask is not compromised because the existing layers are intact and not affected in any way.

The present invention also relates to the use of the coating as defined herein, alcohol-containing solid product as defined herein, the alcohol-containing powder as defined herein, the article of manufacture as defined herein, the textile as defined herein, the antibacterial and/or antiviral paper or plastic as defined herein, the facemask as defined herein, the glove as defined herein, or the filter as defined herein, as an antimicrobial agent, as an antiviral agent, or for inactivating a germ.

In one aspect, the invention relates to the use of a spraying, dipping or painting technique to deposit a layer of a coating or an alcohol-containing solid product as defined herein on a surface to render the surface antimicrobial and/or antiviral. In an embodiment, the spraying technique comprises the use of an electrostatic spray gun.

In another aspect, whilst liquid forms of alcohol, such as gels, are already in use as an antimicrobial and/or antiviral agent, such liquid forms do not provide an antimicrobial and/or antiviral protection over time. This is because the active ingredient (alcohol) evaporates rapidly. The present invention provides for a new and inventive way of inactivating germs on surfaces over a number of days or months. In a particular aspect, the present invention uses a sorbent to sorb an antimicrobial and/or antiviral active agent, such as an alcohol, so that the active agent/alcohol remains encapsulated and does not evaporate, thus rendering it suitable for deposition as an antimicrobial and/or antiviral coating on a surface.

Accordingly, in another aspect, the invention relates to the use of a sorbent to sorb an antimicrobial and/or antiviral active agent, such as an alcohol to render it suitable for deposition as an antimicrobial and/or antiviral coating on a surface. In an embodiment, the sorbent is as defined herein. In an embodiment, the active agent and alcohol are as defined herein. In an embodiment, the weight ratio of sorbing substance to alcohol is in the range of 99:1 to 90:10. preferably in the range of 97.5:2.5 to 94:6.

In another aspect, the invention relates to the use of the coating as defined herein, the alcohol-containing solid product as defined herein, the alcohol-containing powder as defined herein, the article of manufacture as defined herein, the textile as defined herein, the antibacterial and/or antiviral paper as defined herein, the antimicrobial and/or antiviral polymer (natural or synthetic) as defined herein, the antimicrobial and/or antiviral plastic as defined herein, the glove as defined herein, the filter as defined herein, or the facemask as defined herein, as an antimicrobial agent.

The present invention also relates to the use of the coating as defined herein, the alcohol-containing solid product as defined herein, the alcohol-containing powder as defined herein, the article of manufacture as defined herein, the textile as defined herein, the antibacterial and/or antiviral paper as defined herein, the antimicrobial and/or antiviral polymer (natural or synthetic) as defined herein, the antibacterial and/or antiviral plastic, the glove as defined herein, the filter as defined herein, or the facemask as defined herein as defined herein, as an antiviral agent.

The present invention also relates to the use of the coating as defined herein, the alcohol-containing solid product as defined herein, the alcohol-containing powder as defined herein, the article of manufacture as defined herein, the textile as defined herein, the antimicrobial and/or antiviral paper as defined herein, the antimicrobial and/or antiviral polymer (natural or synthetic) as defined herein, the antimicrobial and/or antiviral plastic as defined herein, the glove as defined herein, the filter as defined herein, or the facemask as defined herein, for inactivating a germ.

The present invention also relates to the use of a coating or an alcohol-containing solid product as defined herein for inactivating a germ, wherein the coating or alcohol-containing solid product comprises an alcohol and a carbohydrate. In an embodiment, the alcohol is ethanol. In an embodiment, the carbohydrate is dextran or a dextrin. In an embodiment, the carbohydrate is dextran. In an embodiment, the carbohydrate is a dextrin, optionally selected from selected from alpha-cyclodextrin, beta-cyclodextrin, gamma-cyclodextrin, and Captisol® (Ligand's modified beta-cyclodextrin technology), or a salt thereof. More preferably, the dextrin is gamma-cyclodextrin. In an embodiment, the carbohydrate is gamma-cyclodextrin. In an embodiment, the carbohydrate is Captisol® (Ligand's modified beta-cyclodextrin technology). In an embodiment, the weight ratio of carbohydrate to alcohol is in the range of 99:1 to 90:10. preferably in the range of 97.5:2.5 to 94:6.

The present invention also relates to the use of a coating or an alcohol-containing solid product as defined herein for inactivating a germ, wherein the coating or alcohol-containing solid product comprises an alcohol and a carbohydrate. In an embodiment, the alcohol is ethanol. In an embodiment, the carbohydrate is gamma-cyclodextrin. In an embodiment, the weight ratio of carbohydrate to alcohol is in the range of 99:1 to 90:10. preferably in the range of 97.5:2.5 to 94:6.

In an embodiment, the alcohol-containing solid product further comprises an additive, a natural salt such as rock salt, CaCl₂ or talc.

In an embodiment, the germ is a virus, a bacterium, or a fungus. In an embodiment, the germ is a virus. In an embodiment, the virus is an enveloped virus. In an embodiment, the virus is a non-enveloped virus. In an embodiment, the virus is a coronavirus such as Sars-CoV-1, Sars-CoV-2, a flu virus, HPV, HIV, or norovirus.

In an embodiment, inactivation of the germ occurs within 1 second to 60 minutes. Preferably, inactivation of the germ occurs within 1 second to 5 minutes. A specific example is a 90% reduction in germ viability within 2 seconds.

In another aspect, the present invention resides in the glutaraldehyde (GA) as an antimicrobial and/or antiviral agent wherein the GA is formulated and applied to a surface (as defined herein) as a coating, thereby to impart antimicrobial and/or antiviral properties to the surface. A particularly suitable use for GA is as an antimicrobial and/or antiviral for use on filters such as HVAC filters. It will be appreciated that GA may be the only active agent in a coating formulation or may be co-formulated with either active agents, such as alcohol and/or hypochlorous acid, and ingredients such as plasticisers and carriers as defined herein above. A concentration range of less than about 5%, preferably about 2% or less, or about 0.9% or less of GA in a coating is preferred.

The present invention will now be described in more detail with reference to the following figures, in which:

### FIGURES

FIG. 1: Encapsulation of ethanol in cyclodextrin.

FIG. 2: Encapsulation of ethanol using cyclodextrins (CDs).

FIG. 3: Experimental setup: (A) 0.25 g of β-CD in 5 mL, 10 mL or 15 mL of ethanol. (B) 0.25 g of γ-CD in 5 mL, 10 mL or 15 mL of ethanol.

FIG. 4: Cell death and cytopathic effect (CPE) phenotypes were assessed under a light microscope with 20× magnification using 3% FA fixed L929 cells.

FIG. 5: Antiviral effect of synthesised powders measured against the murine coronavirus. V=vacuum drying, F=freeze drying, without=ambient air drying, 1=samples made with 5 mL ethanol, 2=samples made with 10 mL ethanol, 3=samples made 15 mL ethanol.

FIG. 6: Antiviral behaviour of gamma CD alone compared to CD encapsulated ethanol powders. W=no drying, F=frecze drying, CM=Codikoat protocol method.

FIG. 7: Log reduction was calculated by log ((Initial titre TCID50/mL)/(calculated TCID50/ml)). Our special vacuum preparation provides the best stability for the powdered alcohol upon storage. Our special vacuum preparation provides the best stability for the powdered alcohol upon storage.

FIG. 8: Log reduction was calculated by log ((Initial titre TCID50/ml)/(calculated TCID50/ml)). Surface coating on a fabric with the powdered alcohol is more effective in inactivating more diluted virus samples.

FIG. 9: Log reduction was calculated by log ((Initial titre TCID50/ml)/(calculated TCID50/ml)). Multiple coatings of powdered alcohol on fabrics achieve complete viral inhibition.

FIG. 10: Micropore tape coated with either 1, 2 or 4 layers of adhesive and CM powdered alcohol. Similar to the 4-layer coated samples, excellent antiviral behaviour was observed within 5 minutes.

FIG. 11: Micropore tape coated with either 1, 2 or 4 layers of adhesive and CM powdered alcohol and stored in a closed container for 7 days.

FIG. 12: Micropore tape coated with either 1, 2 or 4 layers of adhesive and CM powdered alcohol undergone accelerated testing and still show excellent antiviral behaviour within 5 minutes.

FIG. 13: A micropore tape coated with 4 layers of CM powdered alcohol.

FIG. 14: Graph showing viral log reduction for powdered alcohol-coated samples using Xanthan gum or PVA glue as adhesive.

FIG. 15: Graph comparing the antiviral effects of cyclodextrin-encapsulated ethanol and cyclodextrin-encapsulated butanol.

FIG. 16: Graph showing the antiviral effect of a composition of 8% PVA and 0.7%-glutaraldehyde on a nitrile substrate.

FIG. 17: Graph showing the antiviral effect of a composition of 8% PVA and 0.1%-glutaraldehyde on a nitrile substrate.

FIG. 18: Graph showing the antiviral effect of a composition of 8% PVA (made with electrolysed water)+1% hyaluronic acid (HA; made with electrolysed water)+35% powdered alcohol (made with ethanol or butanol)+0.07% CPC (cetylpyridinium chloride) on a nitrile substrate.

FIG. 19: Graph showing the antiviral effect of a composition of 8% PVA made with electrolysed water (EW) on a nitrile substrate.

FIG. 20: Graph showing the antiviral effect of an electrospun nanofibre composition of 8% PVA made with electrolysed water on a fabric substrate.

FIG. 21: Graph showing the antiviral effect of a composition of 15% ethyl cellulose made with ethanol with 7000 ppm HOCl.

FIG. 22: A suspension of 5% ethyl cellulose (EC) in 7000 ppm electrolysed water (resolution 10×).

FIG. 23: A suspension of 5% ethyl cellulose. % 15 Ca(NO₃)₂, 15% CaCl₂ in 7000 ppm electrolysed water (resolution 4×).

FIG. 24: Antiviral activity of different formulations coated on the surface of gloves with a surface area 10 cm². Sample formulations were as follows: 5% ethyl cellulose 3 ml (control), 10% glycerol 3 ml (control), 30% glycerol 3 ml (control), 5% ethyl cellulose+0.5% glycerol 3 ml (control), 5% ethyl cellulose+1.5% glycerol 3 ml (control), 1% ethyl cellulose+0.1% glycerol (0.5 ml)+10 kPPM HOCl 20 μl/cm², 1% ethyl cellulose+0.3% glycerol (0.5 ml)+10 kPPM HOCl 20 μl/cm², 1% ethyl cellulose+0.1% glycerol (3 ml)+10 kPPM HOCl 20 μl/cm², 1% ethyl cellulose+0.3% glycerol (3 ml)+10 kPPM HOCl 20 μl/cm², 5% ethyl cellulose+0.5% glycerol (3 ml)+10 Kppm HOCl 20 μl/cm², 5% ethyl cellulose+1.5% glycerol (0.5 ml)+10 Kppm HOCl−20 μl/cm².

FIG. 25: graph showing the effect of storage on antiviral activity: cDMEM (Dulbecco's Modified Eagle Medium) and MHV (Mouse Hepatitis Virus) controls respectively, and a coating sample of 1% ethyl cellulose+10% glycerol (0.5 ml)+10 kPPM HOCl 20 μl/cm² after 3 weeks of storage in either light (wk3L) or dark conditions (wk3D).

FIG. 26: graph showing the effect of temperature on antiviral activity: cDMEM (Dulbecco's Modified Eagle Medium) and MHV (Mouse Hepatitis Virus) controls respectively, and samples a coating of 1% HOCl solution (200 μl sprayed onto samples (10 cm² surface area=20 μl/cm²) exposed to temperatures of 25° C. (room temperature), 50° C. 100° C. and 130° C. respectively for a duration of 30 minutes.

FIG. 27: Antibacterial effect of a coating of 1% ethyl cellulose+0.1% glycerol (0.5 ml)+10 kPPM HOCl 20 μl/cm² on Staphylococcus aureus bacteria. The bacteria Staphylococcus aureus NCTC 10788 was revived from cryogenic storage by streaking on horse blood agar plates and incubated for 24 hours at 37° C. prior to testing. The bacteria inoculum was created by resuspending 5-10 bacteria colonies in buffer solution and diluted 1 in 2 with Mueller Hinton Broth (MHB). This inoculum, referred to as ‘MHB 10788’ containing the bacteria cells in MHB, was spread on Mueller Hinton Agar (MHA) plates prior to testing to provide initial colony counts (Colony forming units/mL) and used as the direct inoculum during the experiment. The buffer bacteria suspension was also separately diluted 1 in 2 in the neutralisation buffer (NB), “NB 10788” and spread on agar plates as a control measure to ensure the NB was having no inhibitory effect on the cells, as this was used for neutralisation/recovery during testing. All plates were incubated for 24 hours at 37° C. prior to counting colonies. The 1/1000 dilution shows the dilution made of the control sample for plating on agar, but all results are extrapolated to the log of CFU/ml. Bacteria were in contact with samples for 0, 1, 2 and 5 minutes. 1 ml of a neat and 1/10 dilution of each sample was then spread onto agar plates and bacterial colony formation counted.

FIG. 28: HEPA filter material (3 cm×4 cm) sprayed with 1.6 wt. % sodium carboxy methyl cellulose (Na-CMC, MW=90 kDa)+0.9 wt. % glutaraldehyde (GA)+2 wt. % methyl blue (MB) at different coating liquid deposition quantities (200 μl (A), 100 μl (B), and 50 μl (c)).

FIG. 29: Graph showing antiviral effect of a formulation of 1.6 wt. % Na-CMC, 0.9 wt. % GA, and 2 wt. % MB spray coated onto HEPA filters. MHVB, MHVA, CFC (commercial filter control), CFMHV (commercial filter+MHV), Fi1C/F1C (Filter 1 control), Fi1T/F1T (Filter 1 test), Fi2C/F2C (Filter 2 control), Fi2T/F2T (Filter 2 test).

FIG. 30: Effect of coatings on filters in droplet antiviral test. FIG. 32A: Control=MHV alone, 1+MHV=HEPA filter alone, 2+MHV=HEPA+2% PEO, 3+MHV=HEPA+2% GA, 4+MHV=HEPA+2% PEO+2% GA; FIG. 32B: positive control=cDMEM, negative control=MHV alone, 1+MHV=HEPA filter alone, 2+MHV=HEPA+2% PEO, 3+MHV=HEPA+2% GA, 4+MHV=HEPA+2% PEO+2% GA.

FIG. 31: Visual effect of spray coating different volumes of a formulation of 2 wt % PEO+2 wt % GA in water on HEPA filters. Samples from top to bottom, left to right: 1. Control=HEPA filter alone, 2. 50 μl PEO+GA, 3. 50 μl PEO+GA+Blue Colour (methylene blue (MB)), 4. 100 μl PEO+GA, 5. 100 μl PEO+GA+MB, 6. 200 μl PEO+GA, 7. 200 μl PEO+GA+MB.

FIG. 32: FIG. 32A: Graph showing pressure drop as a function of flow rate across a HEPA filter spray-coated with a coating formulation of 2% PEO+2% GA. Flow rate is with filter off. FIG. 32B: Graph showing percentage pressure drop as a function of face velocity for different deposition quantities of coating.

FIG. 33: Antiviral effect of coatings tested using a droplet test in which a volume of 250 μl coating was sprayed onto a 12 cm² filter substrate (20.8 μl/cm²). Positive control=cDMEM, negative control=MHV, 1+MHV=uncoated HEPA filter+MHV, 2+MHV=filter coated with 2% PEO, 3+MHV=filter coated with 2% GA, 4+MHV=filter coated with 2% GA+2% PEO.

FIG. 34: Antiviral effect of PEO+GA coating using a droplet test 5 weeks post spray coating. Positive control=cDMEM, negative control=MHV, 1+MHV=uncoated HEPA filter+MHV, 2+MHV=filter coated with 2% PEO, 3+MHV=filter coated with 2% GA, 4+MHV=filter coated with 2% GA+2% PEO.

FIG. 35: Anti-bacterial effect of HEPA filters coated with the following formulations: 2% PEO+2% GA, 1) HEPA only, 2) PEO 2% only, 3) GA 2% only, 4) PEO 2%+GA 2%. All volumes 250 μl.

FIG. 36: Anti-bacterial effect of HEPA filters coated with the following formulations: CMC (90K) and 1.6% CMC (90K)+2% GA.

FIG. 37: Antiviral effect of GA when mixed with sodium carboxymethylcellulose (Na-CMC) at different molecular weights, or hydroxyethylcellulose (HEC), using antiviral droplet test. Positive control=cDMEM, negative control=MHV alone, control=HEPA filter+MHV, 1+MHV=CMC (90K), 2+MHV =CMC (90K)+2% GA, 3+MHV=CMC (250K), 4+MHV=CMC (250K)+2% GA, 5+MHV=CMC (700K), 6+MHV=CMC (700K)+2% GA, 7+MHV=HEC, 8+MHV=HEC+2% GA.

FIG. 38: Graph showing the effect of different molecular weights and substitution numbers for CMC, together with hydroxypropylmethylcellulose (HPMC) as an alternative polymer, on the antiviral efficacy of formulations coated on HEPA filters using the antiviral droplet test. Positive control=cDMEM, negative control=MHV alone, control=HEAP filter alone+MHV, 1+MHV=2% GA only, 2+MHV=2% Methylene Blue (MB) only, 3+MHV=1.6% Na-CMC (90K)+2% GA+2% MB, 4+MHV=1.6% Na-CMC (90K) only, 5+MHV=1.6% Na-CMC (90K)+2% GA, 6+MHV=1.3% Na-CMC (250K)−substitution number (SN) 0.7 only, 7+MHV=1.3% Na-CMC (250K)−SN 0.7+2% GA, 8+MHV=1.3% Na-CMC (250K)−SN 1.2 only, 9+MHV=1.3% Na-CMC (250K)−SN 1.2+2% GA, 10+MHV=0.6% Na-CMC (750K) only, 11+MHV=0.6% Na-CMC (750K)+2% GA, 12+MHV=1% HPMC only, 13+MHV=1% HMPC+2% GA.

FIG. 39: Graph showing results of antiviral droplet test on varying volumes of sprayed formulations (50. 100 and 200 μl) on 12 cm² HEPA filter substrates (4.16. 8.3 and 16.7 μl/cm²). Positive control=cDMEM. negative control=MHV alone, test control=HEPA filter+MHV, 1+MHV=200 μl 1.6% Na-CMC (90k) alone, 2+MHV=50 μl 0.9% GA alone, 3+MHV=100 μl 0.9% GA alone; 4+MHV=200 μl 0.9% GA alone, 5+MHV=50 μl 1.6% Na-CMC (90K)+0.9% GA+2% MB. 6+MHV=100 μl 1.6% Na-CMC (90K)+0.9% GA+2% MB, 7+MHV 200 μl 1.6% Na-CMC (90K0+0.9% GA+2% MB.

FIG. 40: FIG. 40A: Graph showing pressure drop as a function of flow rate (L/min) for a HEPA filter spray coated with a formulation of 1.6 wt % Na-CMC (MW 90K)+0.9 wt % GA+2% wt % MB. FIG. 40B: graph showing percentage pressure drop as a function of face velocity for different deposition quantities (50, 100 and 200 μl) of a HEPA filter spray coated with a formulation of 1.6 wt % Na-CMC (MW 90K)+0.9 wt % GA+2% wt % MB.

FIG. 41: Graph showing results of antiviral droplet test on volumes of 50 μl and 100 μl 0.9% GA formulations spray-coated on a HEPA filter. Positive control=cDMEM, negative control=MHV only, 1+MHV=HEPA, 2+MHV=50 μl 20 Kppm HOCl, 3+MHV=100 μl 20 Kppm HOCl, 4+MHV=50 μl 1.6% Na-CMC (90K), 5+MHV=100 μl 1.6% Na-CMC (90K), 6+MHV=50 μl 0.9% GA, 7+MHV=100 μl 0.9% GA, 8+MHV=50 μl 0.9% GA+20 Kppm HOCl, 9+MHV=100 μl 0.9% GA+20 Kppm HOCl, 10+MHV=50 μl 1.6% Na-CMC+0.9% GA+20 Kppm HOCl, 11+MHV=100 μl 1.6% Na-CMC+0.9% GA+20 Kppm HOCl, 12+MHV=50 μl 1.6% Na-CMC+0.9% GA+20 Kppm HOCl+2% MB, 13+MHV=100 μl 1.6% Na-CMC+0.9% GA+20 Kppm HOCl+2% MB.

FIG. 42: Pressure drop test at 50 μl (4.6 μl per cm²) vs 100 μl (8.3 μl per cm²) of the formulations of FIG. 41, spray-coated onto a HEPA filter.

FIG. 43: Graph showing the stability of a 1.6% CMC (90 kDa)+2% GA coating formulation (250 μl) 3 weeks after spray coating using the antiviral droplet test. Control=MHV, 1+MHV=HEPA filter only, 2+MHV=1.6% Na-CMC (90K), 3+MHV=2% GA only, 4+MHV=1.6% Na-CMC (90K)+2% GA.

### DETAILED DESCRIPTION OF THE INVENTION

The present invention relates to an antimicrobial and/or antiviral formulation that is suitable for use as a coating to impart antimicrobial and/or antiviral properties to a surface on which the coating is laid. Without wishing to be bound by theory, the formulation or coating described herein inactivates viruses and bacteria as described below.

Virus and bacteria contain proteins on their surfaces. These proteins, some called “Spike Proteins”, allow entry into a host and evade immune surveillance where possible. Even though viral products originate from its genetic material RNA and/or DNA, which make up the most important part of the pathogen, targeting proteins on their surfaces should be the first strategy to design an antimicrobial surface for human use.

Proteins are encoded from the genetic material and formed by both essential and non-essential amino acids that share a common structure except the variable region R. Depending on the nature of amino acids, the R region adopts neutral, charged (positive or negative) and/or hydrophobic properties which shape the overall charge and conformation of a given protein as well as its interaction with other molecules such as other proteins, lipids and nucleic acids.

Protein denaturation results in the disruption of conformation and interaction between charged and hydrophobic amino acids per se. This results in a functional loss of the protein.

The most common protein denaturing agent used as an antimicrobial agent is ethyl alcohol (EtOH), which also helps dissolve bacterial plasma membranes at 70% concentration. EtOH denatures proteins in two ways: by coagulation and by breaking the hydrogen bonds and salt bridges, thus destroying the protein conformation.

Coagulation happens when 90% or more concentrations of EtOH is used. This is not considered as the most effective way of disinfecting. This is because 90% or more concentrated EtOH can coagulate all the proteins on the surface of a virus or bacteria and thus may not be able to penetrate inside the virus or bacteria. Therefore, 70-75% concentrations of EtOH solution are recommended for use a as disinfectant. EtOH can also disrupt hydrogen bonds and salt bridges in proteins and eventually denature them. To compete with hydrogen bonds, EtOH must be in a specific conformation so that H⁺ groups are able to attack the protein hydrogen bonds. The best conformation of EtOH for antimicrobial effect is achieved at 70-75% concentrations, allowing an (E) conformation (as shown below) as opposed to (Z) conformation.

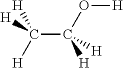

### EtOH (E) Conformation

It is against this background that the present invention has been devised. In particular, the present invention resides in an antimicrobial and/or antiviral coating comprising: i) at least one non-biological antimicrobial and/or antiviral agent; and ii) a polymer carrier.

There are many considerations when designing a coating, not least maintaining antimicrobial and/or antiviral properties in the active agent during formulation, but also creating a coating that is fit for purpose, i.e. is easily applied, adheres to a surface and is and remains active for a suitable length of time, usually through wear and tear. Such a consideration is particularly pertinent when using alcohol as the antimicrobial and/or antiviral (active) agent. While the present invention encompasses a coating that may include alcohol, other active agents are also contemplated and exemplified.

### EXAMPLES

As described in Examples 1 and 2, powdered alcohol was first manufactured by the present inventors according to a known protocol and tested for its effectiveness against murine coronavirus. The results obtained suggested that ethanol encapsulated in gamma-cyclodextrin showed superior antiviral activity compared to beta cyclodextrin encapsulated ethanol, and that powdered alcohol dried using vacuum oven drying resulted in a more efficient antiviral activity of the powdered alcohol. Standard tests to measure antiviral and antimicrobial properties include cytopathic effect (CPE) inhibition assay, plaque assay, qPCR assay, flow cytometry, and TCID50 infectivity assay.

### Example 1. Preparation of Powdered Alcohol by Diffusion Based on Prior Art Method

For developing powdered alcohol, initial experiments were adapted based on existing Cyclodextrin (CD) encapsulation procedures described previously (Thesis entitled “Synthesis and Characterization of Gamma Cyclodextrin Metal Organic Framework and Encapsulation of Ethanol”, An-Katrienin Pauwels, 2019: http://hdl.handle.net/1942/29463).

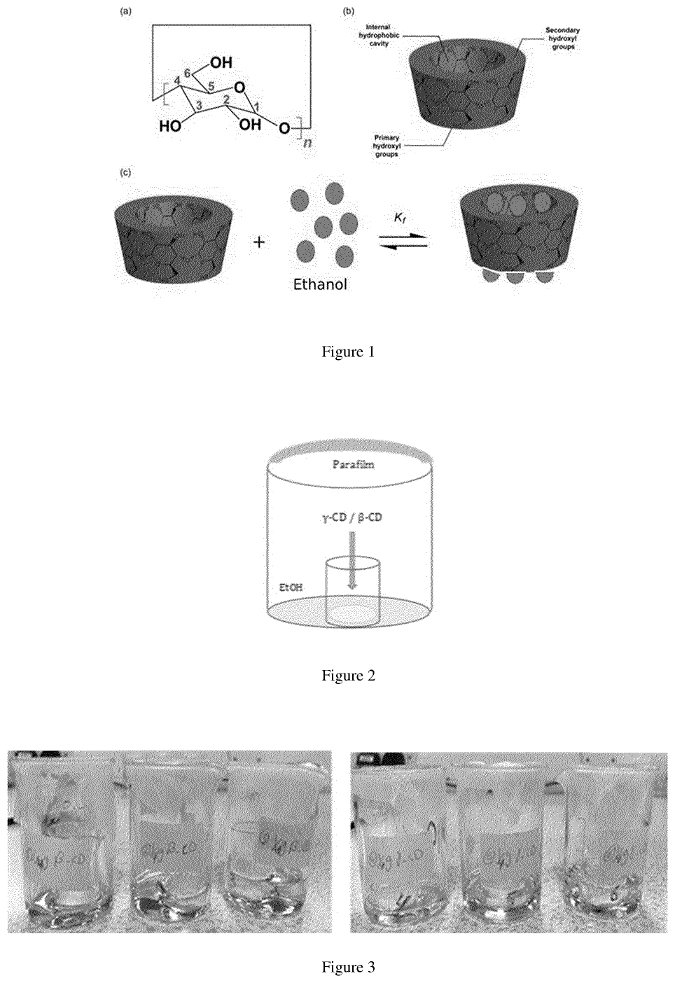

Two types of cyclodextrins were tried for encapsulating ethanol (Beta (β), Gamma (γ)). More alcohol encapsulation in sugars with larger diameters was expected as opposed to those sugars with smaller diameters (due to more space for ethanol encapsulation), indicating enhanced viral inhibition upon contact with the powdered alcohol with increasing diameters (see FIG. 1).

Encapsulation of ethanol was carried out after putting two samples of 0.25 g γ-CD, and β-CD separately into individual 50 ml beakers. The small beaker was placed in a bigger glass jar and different amounts of ethanol were added to the glass jar as shown in FIGS. 2 and 3. The jar was covered with parafilm as the jar was left for 48 hours. The encapsulation took place by diffusion mechanism during this time.

After completion of 48 h diffusion, in order to dry the reaction mixture to obtain the powdered alcohol, three drying techniques were tested and evaluated. Each jar was divided into three parts; the first part was dried by the freeze-drying method, the second part by vacuum oven and the last part was left at room temperature without any specific treatment (i.e. ambient air drying at room temperature of about 17° C.).

TABLE 1
Ethanol microencapsulation with cyclodextrins:

| | Drying by | Drying by | | |
|---|---|---|---|---|
| | Vacuum | freeze | Ambient air | |
| Samples | oven 35° C. | dryer 0° C. | drying | Descriptions |
| 1 β-CD | 1V β-CD | 1F β-CD | 1β-CD without | Diffusion in 5 |
| | | | | mL of Ethanol |
| 2 β-CD | 2V β-CD | 2F β-CD | 2β-CD without | Diffusion in 10 |
| | | | | mL of Ethanol |
| 3 β-CD | 3V β-CD | 3F β-CD | 3β-CD without | Diffusion in 15 |
| | | | | mL of Ethanol |
| 1 γ-CD | 1V γ-CD | 1F γ-CD | 1γ-CD without | Diffusion in 5 |
| | | | | mL of Ethanol |
| 2 γ-CD | 2V γ-CD | 2F γ-CD | 2γ-CD without | Diffusion in 10 |
| | | | | mL of Ethanol |
| 3 γ-CD | 3V γ-CD | 3F γ-CD | 3γ-CD without | Diffusion in 15 |
| | | | | mL of Ethanol |

### Example 2. Testing of Powders Obtained in Example 1 for Their Effect on Murine Coronavirus

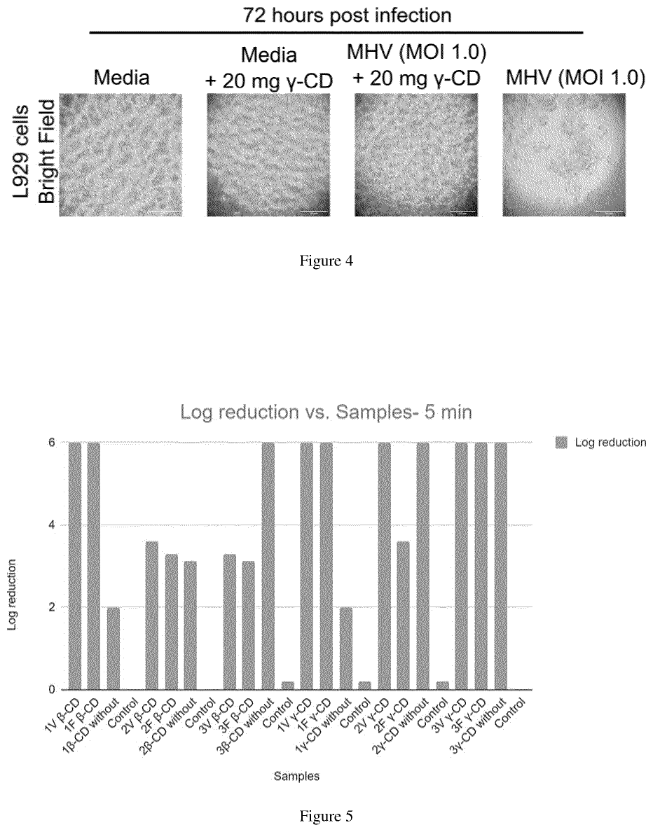

The powders obtained in Example 1 were tested for their effectiveness in inactivating the murine coronavirus in 5 minutes using L929 cells. L929 cells at 5×10⁵ cells/ml concentration in 100 μl volume in a 96 wells format were used. First, the virus stock was diluted 10 times in 1×PBS. Then 20 μl MHV (multiplicity of infection [MOI] 3.0) was mixed with 10 mg and 20 mg powdered alcohol for 5 minutes at room temperature with repetitive pipetting to maximise the interaction between the virus and powdered alcohol. To mitigate the potential side effects of the powdered alcohol on L929 cells, powder treated cell culture media (cDMEM) was prepared as a control. After recovering the virus and the control media from the mixture, treated samples (triplicates) were immediately diluted in 20 μl cDMEM, thereby bringing the final MOI to 1.0. In a 96 wells format, 8 serial dilutions (DF=5.0) were prepared per sample together with non-treated virus and cell culture media (cDMEM) as positive and negative controls, respectively. Cell infection phenotype as cell death and cytopathic effect (CPE) was observed under a benchtop light microscope (20× magnification) at 24-, 48- and 72-hours post infection (hpi) intervals (FIG. 4). TCID50/ml values per experiment were calculated at 72 hpi using Reed&Muench Calculator.

As shown in FIG. 5, ethanol encapsulated in gamma-cyclodextrin overall, showed superior antiviral activity compared to beta cyclodextrin encapsulated ethanol (complete viral inhibition compared to positive and negative control). At the highest ethanol concentration tested (15 mL), all drying techniques were as effective. The vacuum drying technique seemed to be the most optimum method at different ethanol concentrations. The observation of complete viral inhibition using γ-CD compared to other CDs is consistent with the idea of more EtOH encapsulation in CDs with larger diameters.

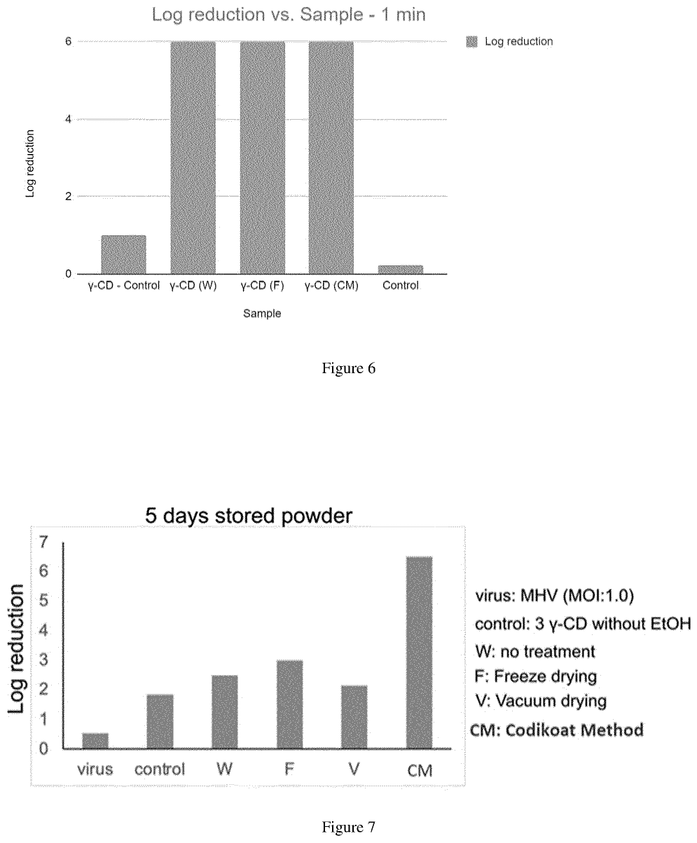

The inhibition of MHV by γ-CD powdered alcohol obtained in Example 1 was further tested at different time intervals. Treatments with fresh γ-CD (15 ml EtOH encapsulation) for 1 minute at room temperature using the same protocol as described above. It was demonstrated that 1-minute treatment of the MHV with γ-CD (15 ml EtOH) is effective enough to completely inactivate the virus (FIG. 6).

In order to demonstrate the enhanced antiviral mechanism when encapsulating ethanol in CD, and their synergic effect, the previous results were compared with preparations of gamma-CD alone. This experiment (FIG. 6) demonstrated that CD encapsulated ethanol displays significantly higher antiviral behaviour compared to CD alone (6 log reduction vs 1 log reduction), thus indicating the important role of EtOH denaturation of proteins on the viral structure.

### Example 3. Stability of the Powdered Alcohol Obtained in Example 1

In order to assess the stability of the powdered alcohol stored for 5 days at room temperature (dark, sealed container), MHV was treated with powder for 1 min for L929 cell infection assay. Interestingly, γ-CD (15 ml EtOH encapsulation) prepared by freeze-drying (F), ambient air drying (W) or vacuum drying (V) have partially lost their antiviral activity (FIG. 7). Nevertheless, the antiviral activity was still higher than CD alone control and no treatment control (3 or 4 log viral reduction).

### Example 4. Preparation of Powdered Alcohol by Directly Mixing Alcohol and Cyclodextrin

To improve the stability of the powders and to retain antiviral properties for longer times, the powders using a novel approach were synthesised. In this approach, instead of allowing the ethanol to diffuse for 48 hours in the jar (as explained in FIG. 2), low volume of ethanol (1 mL) was directly mixed with CD in a beaker and left for only 24 hours. In this preparation, 0.3 g of γ-CD or β-CD was mixed with 1 mL of ethanol for 10 minutes hours and dried inside a vacuum oven for 24 hours. To the best of our knowledge this is the first time such a procedure has been used for developing CD-encapsulated ethanol. Importantly, this method reduces the synthesis time of the powders which will be hugely beneficial for upscaling and manufacturing in large scale. This new method also had higher production efficiency as a significantly lower volume of ethanol was used for preparation.

### Example 5. Effect of Powdered Alcohol on Murine Coronavirus

The powders generated in Example 4 (termed CM powder or the CodiKoat Method powder) also demonstrated excellent antiviral behaviour, similar to the powders that were generated using the initial (previously published) protocols that were used in Example 1 (FIG. 6). The stability of this powder was tested following 5 days of storage in conditions similar to that previously described, γ-CD (15 ml EtOH encapsulation) prepared by methodology described herein (CM) did preserve its 100% antiviral activity (FIG. 7) upon long term (5-day) storage compared to all conventional methods of preparation (dried by natural, freeze and vacuum drying).

It was demonstrated that the vacuum dried 3-gamma CD produced by the CodiKoat method (CM) had a superior antiviral effect compared to the other samples but also a very high stability.

### Example 6. Antiviral Effect of a Powdered Alcohol Coating on a Fabric Facemask

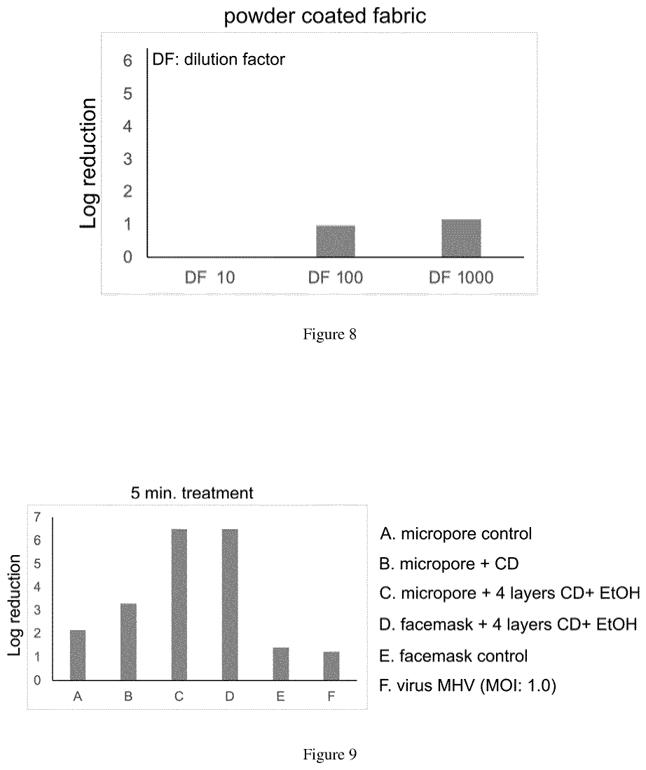

Having established the technical and chemical preparation of the powdered alcohol, 100 mg of CM γ-CD (15 ml EtOH encapsulation) were manually coated on commercially available face mask fabrics having a surface of 5 cm×5 cm. In a real-time scenario, powdered alcohol coated face masks were expected to protect individuals from aerial transmission of SARS-COV-2 via fomites. Given the relatively lower concentrations of viral titres in fomites compared to conditions being used in previous experiments. MHV (MOI 3.0) with 10, 100 and 1000 dilution factors (DF) was tested on these manually coated fabrics. For this, 5 μl of diluted virus were left on the surface of the fabric for 5 minutes at room temperature. Then, the soaked virus was recovered with 15 μl 1×PBS by extensive pipetting. L929 cells and viral titrations were performed as described above. In contrast to DF 10, higher dilution series proved to be relatively more efficient in inactivating the virus using the powdered alcohol (FIG. 8). However, this level of reduction is less than was observed in previous experiments directly mixing the virus and the powdered alcohol. This clearly demonstrates the need for further optimisation such as viral recovery upon treatment and multiple layers of powdered alcohol in the fabric coating.

Following the dilution factor optimisation, it was speculated whether multiple layers of powdered alcohol on fabrics or face masks could provide a better antiviral strategy given the high concentration of powdered alcohol in complete viral inhibition. For this, micropore or face mask fabrics coated with the powdered alcohol were prepared with 4 layers (for each layer, 4.4 mg of powdered alcohol is used per square centimetre of surface to coat). 5 μl of MHV (MOI: 3.0) diluted in 1×PBS was then incubated on 10 mm×10 mm dissected fabrics on a solid surface for 5 minutes. Treated virus was then recovered using a buffer containing cDMEM+0.7% Tween80 (conditions similar to ISO standards for testing fabrics) with consistent pipetting and vortexing for 25 minutes at room temperature, bringing the final virus MOI to 1.0. The recovered virus was subsequently used for serial dilutions with dilution factor (DF) equal to 5 and monitored the infection results at 24, 48 and 72 phi. It was demonstrated that multiple layers of powdered alcohol on both micropore and facemask fabrics proved to be 100% efficient to inactivate the MHV, compared to fabric and CD controls (FIG. 9).

### Example 7. Antiviral Effect of Coating of Powdered Alcohol on Micropore™ Tape

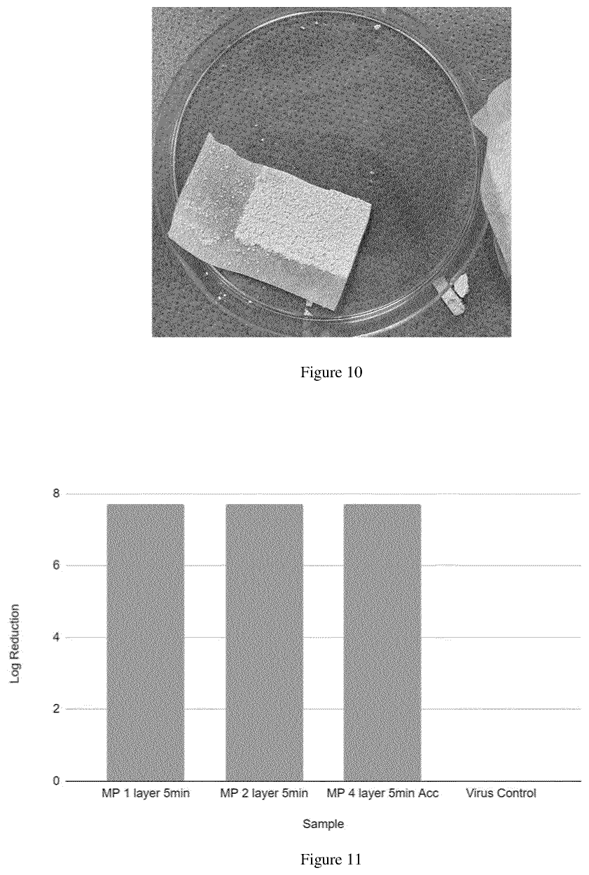

Following promising results from the four-layer coated samples, attempts were made to reduce the number of coating layers and further tested one and two-layer coated micropore tapes for antiviral behaviour. Similar to the four-layer coating, great results were also obtained with one and two layers of coating (FIG. 10).

The one, two and four-layer samples were further tested after 7 days of storage and great results were obtained also (FIG. 11). The samples still show great stability with no reduction in antiviral effect.

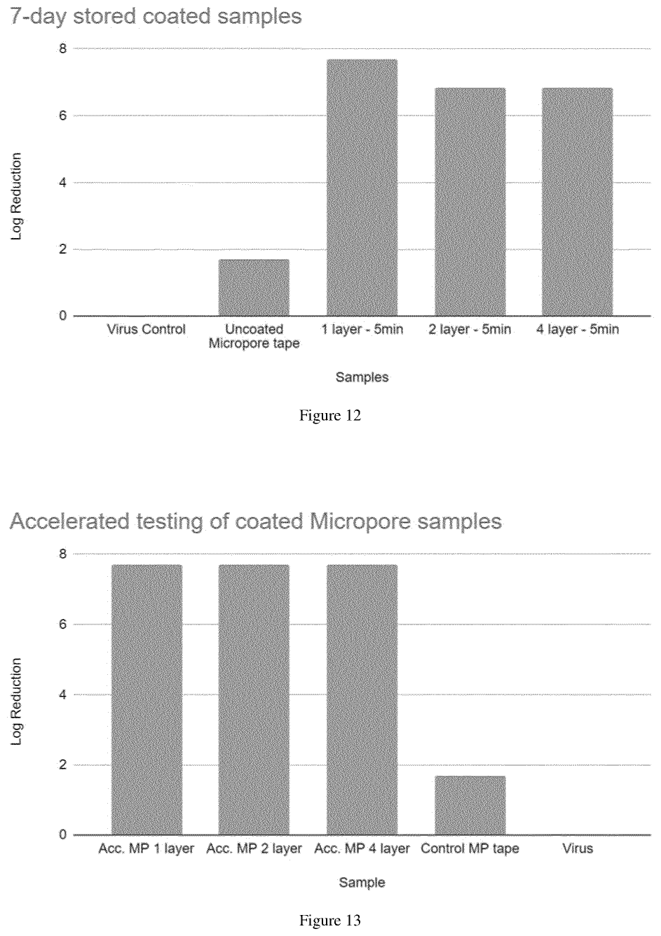

Accelerated testing was also performed on the one, two and four-layer samples where PBS (×3) was sprayed using a nasal spray dispenser on fabrics from a distance of 5 cm. This procedure was repeated after 30 mins and another after 60 mins (i.e. nine sprays in total). This resembled three days of use with an average of three sneezes per day. Great results were obtained for all samples with no deterioration of antiviral effects (FIG. 12).

### Example 8. Deposition of Powdered Alcohol on an Adhesive Surface

The ‘sticky’ adhesive side of the tape was sprayed uniformly using an industrial (‘electrostatic’) coating spray gun (e.g. the Encore LT System from Nordson for manual spraying or the automated robotic equivalents for large scale production) or any other appropriate coating spray guns. Spray guns are used for reliable, easy powder spraying in order to provide a uniform coating on the nanoscale/microscale format.

The number of CM powder layers can be adjusted by application. The higher the number of layers the longer the antiviral coating will last. Although there is a trade-off between this durability and breathability of a fabric such as that used for a facemask.

For depositing a few layers of the CM powders on the antiviral layer (either the extra paper or the high density filter layer), the use of natural adhesive and gums are proposed (examples include Xanthan gum, gum arabic, starch glue or dextrin glue). This is also ideal as it improves the safety of the powder coatings. In the samples tested (FIG. 9), Xanthan gum was used for adhesion. The preparation of Xanthan gum and Surface coating is as follow:

2 grams of Xanthan gum was gradually added to 100 mL of warm water (50°C.) while it was stirred with a magnetic stirrer bar in a 200 ml beaker. Once dissolved, the viscous solution was cooled down.

A thin layer of this solution (approximately 0.05 g) was then applied on the fabric surface (7.5* 10 cm area) by using a brush. After a 1 minute interval, 0.2 gram of CM powdered alcohol was sprayed homogeneously on the top of the first layer of Xanthan by using a spray pump. For the subsequent layer, a 5 minute interval was allowed (for drying/stabilising the gum and powder layer) before applying another 0.05 g of Xanthan layer using a brush as previously described. Following 1 minute 0.2 g of CM powder was sprayed as described. This procedure was repeated until the desired number coating layers was reached. A five layer sample therefore will have a total of 1 g of powdered alcohol. FIG. 13 shows a four-powder layered micropore tape.

### Example 9: Alternative Polymer Carriers

Previous examples used water-based adhesives such as Xanthan Gum for fixing the powder in place. Olewnik-Kruszkowska E. et al (Polymers (2019) 11, 2093) suggest that chitosan has antifungal and antibacterial properties which are enhanced when combined with poly(vinyl alcohol) (PVA). Both PVA and chitosan, as well as materials based on them, have found many applications in medicine, pharmaceuticals, and materials that come into contact with food. This is in particular due to their biocompatibility, biodegradability, and low or even complete lack of toxicity. Their good miscibility is the result of the hydrogen bonds formed between their functional groups. Therefore, blending PVA and Chitosan contributes to homogeneous materials with antimicrobial properties and better mechanical properties than chitosan alone. Olewnik-Kruszkowska E. et al (supra) demonstrated that both a pure PVA film and a PVA-Chitosan film do not exhibit any antibacterial properties.

Importantly in the context of the present invention. PVA is a water-based adhesive. Moreover, PVA has an excellent safety profile and is used as an adhesive for children's school tasks. PVA is also FDA approved for clinical uses in humans. Accordingly, its ability to act as antimicrobial/antiviral agent was investigated and a solution of PVA was used to coat the surface of a fabric to form an adhesive layer: 10 g PVA was placed into a 100 ml beaker containing 50 ml deionised water, the mixture was boiled for 3 minutes then the solution was kept overnight at room temperature.

The prepared glues were applied as adhesive for keeping the alcohol encapsulated CDs (powdered alcohol) on the surface of fabrics and gloves. The fabric was polypropylene melt-brown non-woven fabric which is typically used in the filter layer of IIR standard facemasks. A layer of this solution was used to cover the surface of a fabric sample (2 cm×2 cm) and was left for a minute. The thickness of the layer of glue was about 5 mm. Then CD encapsulated alcohol was sprayed on the top of the glue coated surface. The sprayed powder on the surface was pressed to increase the amount of the powder on the surface of the fabric. The total amount of CD encapsulated alcohol powder on the surface was 450 mg. To compare the antiviral activity of powder-coated fabrics with different adhesive solutions, the antiviral tests comparing murine coronavirus (MHV) with cell culture medium (cDMEM) described above were performed:
1) Fabric−Xanthan gum+Powdered Alcohol×1 2×2 cm
2) Fabric−Xanthan gum+Powdered Alcohol×1 2×2 cm
3) Fabric−PVA glue+Powdered Alcohol×1 2×2 cm
4) Fabric−PVA glue+Powdered Alcohol×1 2×2 cm

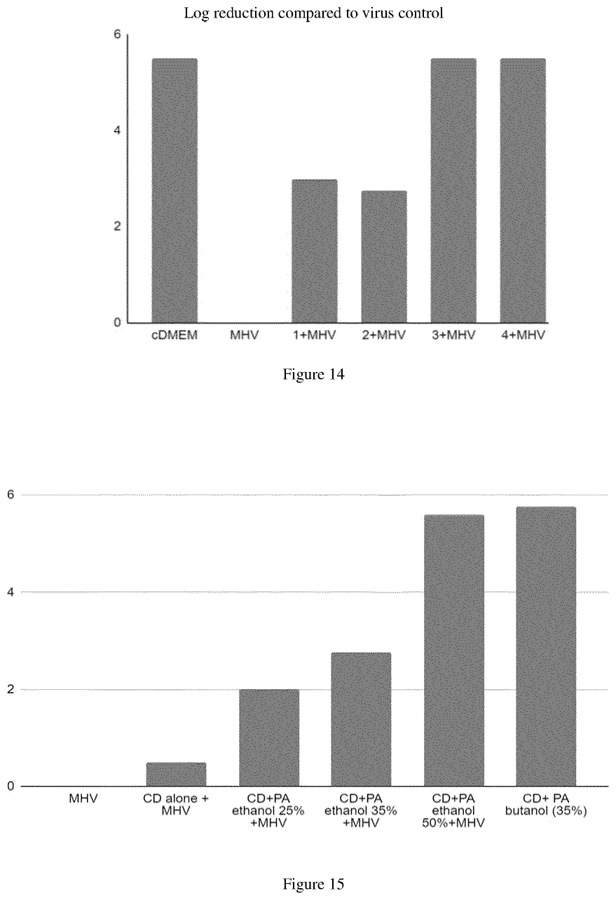

Formulations including PVA adhesive demonstrated strong antiviral behaviour with almost complete inhibition of the virus. In comparison, the fabrics coated with a formulation including Xanthan gum demonstrated 2-3 viral log reduction (FIG. 14).

This experiment demonstrated that PVA complements powdered alcohol in producing an enhanced antiviral behaviour.

### Example 10. Modifying PVA Properties

In this example, the properties of PVA were modified using electrospinning to create PVA nanofibres to improve breathability for facemask purposes and also increase the contact surface area between virus and antiviral agent (powdered alcohol)

The creation of nanofibres using the electrospinning technique had two main motivations. Firstly, for applications such as facemask where breathability is an important factor, having a coating that is sprayed or brushed on the fabric can block the micropores of the fabric and therefore greatly impact the breathability. Therefore, the creation of nanofibres was sought for the antiviral coating to offer antiviral protection but at the same time improve breathability. Another advantage of this idea would be that it would offer enhanced protection against coronavirus as the diameter of the virus particles are in the nanometre range (˜50 nm-100 nm) whereas current widely available blue surgical facemasks have pores larger than the virus (micron sized pores). Hence, in theory, the virus is able to penetrate the pores in the current surgical facemasks. The solution proposed here addresses this concern as the nanofibres should block the micron sized pores making them nanosized pores.

The second motivation behind this idea was that increasing the contact surface area between the virus and the antiviral agent, in theory, has the capability to improve the antiviral behaviour of coating. However, there are other parameters that can, in theory influence, this hypothesis. For example, the antiviral agent may evaporate during the electrospinning process and therefore provide a lower concentration of antiviral agent per unit volume/gram of the coating.

### Electrospinning:

Fibre diameters in the nano-range have great advantages in volume-to-mass and strength-to-weight ratios. Although conventional textile fibres have a fibre diameter ranging from 5 to 50 μm, electrospinning is a technology that enables the production of continuous nanofibres of the order of 10⁻⁹ m from polymer solutions or melts in high electric fields. Electrospinning is a fibre-spinning technique that relies on electrical forces to produce fibres in the micrometre to nanometre range. Under the influence of an electric field, a pendant droplet of the polymer solution or melt at the spinneret is deformed into a conical shape (Taylor cone). If the voltage surpasses a threshold value at which electrical forces overcome the surface tension, a fine charged jet is ejected. As these electrical forces increase, the jet will elongate and accelerate by the electrical forces. The jet undergoes a variety of instabilities, dries, and deposits on a substrate as a random nanofibre mat. A typical polymer is dissolved in a solvent or combination of solvents with a viscosity ranging from 1 to 200 Poise.

It has been found that the morphology, such as the fibre diameter, and uniformity of electrospun polymer fibres are dependent on many processing parameters, including volume feed rate in the spinneret, external electric field, polymer concentration, molecular weight of the polymer, viscosity, conductivity, dielectric permeability, surface tension, distance from the spinneret to the collector, and ambient conditions. As a result, most nanofibres obtained so far are in a nonwoven form which can be useful for different applications such as filtration, tissue scaffolds, coating films and wound dressings.

### Example 11. Texture of Powdered Alcohol (PA) in PVA

This example investigated the texture of the antiviral/antimicrobial product. Deposition of powdered alcohol in water-based adhesives produced a coarse and grainy texture which is uncomfortable to the touch when coated on a surface. In addition, such a texture shows a low ability to adhere to a surface. One reason for this is because the powder grains stand proud of the surface and so are easily rubbed or knocked off when the surface is in use. Accordingly, there was a need to create a smoother, finer texture, ideally a uniform rubbery or gel-like coating.

The coating process used in previous examples involved an initial application of at least one layer of adhesive to fix the powder alcohol that then was sprayed on the surface. This process gave rise to a powdery/grainy coating. To create a uniform smooth gel like (rubbery) coating, the powdered alcohol was dissolved in the PVA solution, and the powder/adhesive mixture was sprayed on the substrate. In this scenario the ethanol active groups in the solution, in theory, should remain stable as they should be protected by the cyclodextrin rings that are encapsulating the ethanol OH groups. However, upon testing this hypothesis, it was demonstrated that the antiviral behaviour of the coating was greatly diminished (data not shown) and this could be attributed to the spread and dilution of the powdered alcohol (PA) in the solution. From earlier experiments (data not shown), it is believed that a minimum ratio of 1:2 w/v% (PA:virus) is required for sufficient and suitable antiviral activity.

### Example 12. Enhancing Antiviral Effect of the Coating

In this example, the use and addition of other antimicrobial ingredients was investigated with the aim of improving the antiviral behaviour of the coating.

To create a powder with a stronger antiviral/antimicrobial effect, a stronger acting alcohol was investigated. There are a variety of alcohols that, depending on the number of carbon chains, differ in strength. Although ethanol is the safest alcohol available as it is also used in food and beverages, butanol also has a relatively acceptable safety profile for disinfectant purposes such as use in hand gels. Butanol has four carbon chains. while ethanol has two, and therefore is theoretically a stronger alcohol. Accordingly, a powdered alcohol formulation was prepared with butanol encapsulated by cyclodextrin. The procedure for synthesising the butanol-encapsulated cyclodextrin was the same as for the preparation of an ethanol-cyclodextrin powder and as described above.

As shown in FIG. 15, the cyclodextrin-encapsulated ethanol powder displayed about a 3 log reduction when the virus was suspended directly into the powder. In contrast, about a 6 log reduction was observed when the cyclodextrin was encapsulated with butanol. Even at 50%, CD PA ethanol did not behave as well as CD+PA butanol at 35%. All contact times were equal (1 minute).

Taking inspiration from the inventors' knowledge that water hydrolysis kills viruses and microbes, the use of an active agent created as part of water hydrolysis was investigated. The main active ingredient in electrolysed water (EW) is hypochlorous acid (HOCl) which is a strong and safe disinfectant. One challenge with a solution of HOCl is stability as the acid deteriorates relatively rapidly. In addition, one of the main reasons why EW is not widely available or found on supermarket shelves is its short shelf life as the product deteriorates rapidly when exposed to sunlight and open air. Moreover, HOCl solution by itself is very watery and cannot be used as a coating on substrates such as latex and neoprene (e.g. surgical or disposable gloves). Therefore, the inventors postulated that encapsulating HOCl in cyclodextrin could be a good way to stabilise HOCl, as seen with ethanol, while retaining the compound's chemical properties.

However, encapsulating HOCl in cyclodextrin is challenging as cyclodextrin is soluble in water and dissociates/disintegrates rapidly in water before being able to encapsulate dissolved HOCl. Therefore, the stabilisation of HOCl in PVA before or without cyclodextrin encapsulation was investigated.

A concern with powdered alcohol dissolved in water-based adhesives is that a coarse and grainy textured product is produced which is uncomfortable to the touch when coated on a surface. In addition, such a texture shows a low ability to adhere to a surface. One reason for this is because the powder grains stand proud of the surface and so are easily rubbed or knocked off when the surface is in use. Accordingly, there was a need to create a smoother, finer texture, ideally a uniform rubbery or gel-like coating and it was suggested that HOCl stabilised in PVA without encapsulation may create a rubbery, gel-like solution that might be more suitable for use as a coating solution.

Other known antimicrobial agents were also investigated in the formulation, such as metal oxides (e.g. Tio2, Zno, AgNO3), poloxamers including poloxamer 407, quaternary ammonium salts (QAS) salts such as CPC (cetylpyridinium chloride), fluoride ions, chitosan, poly(hexamethylene guanidine) (PHMG), carnosol and alpha-tocopherol, glutaraldehyde or hyaluronic acid, citric acid and acetic acid. Different combinations and concentrations of the above additives were added to the formulations before coating.

All agents listed above were tested and the coatings that demonstrated the most promising antiviral behaviour are listed below. Experiments shows that the antimicrobial activity of hyaluronic acid came from its action of protecting cells from virus penetration, rather than cidal activity, and so the agent is of limited use in the context of the present invention.

a) 8% PVA (2 kda)+glutaraldehyde (0.7%-3%):

Synthesis method: 8.0 g of poly vinyl alcohol (PVA) purchased from (TCI, M_{w}2000 Dalton) was placed into a 200 ml beaker containing 100 ml Milli-Q water. The solution was warmed to 40° C. for 3 hours with stirring 700 rpm. 0.7% w/v of glutaraldehyde (GA) was then dissolved and the solution stirred. Next, pieces of gloves (Nitrile) were cut (6×6 cm dimensions) and coated by the solution prepared above. Samples were either brushed and/or sprayed and put in the oven for an hour for drying at 60° (see Example 15 below).

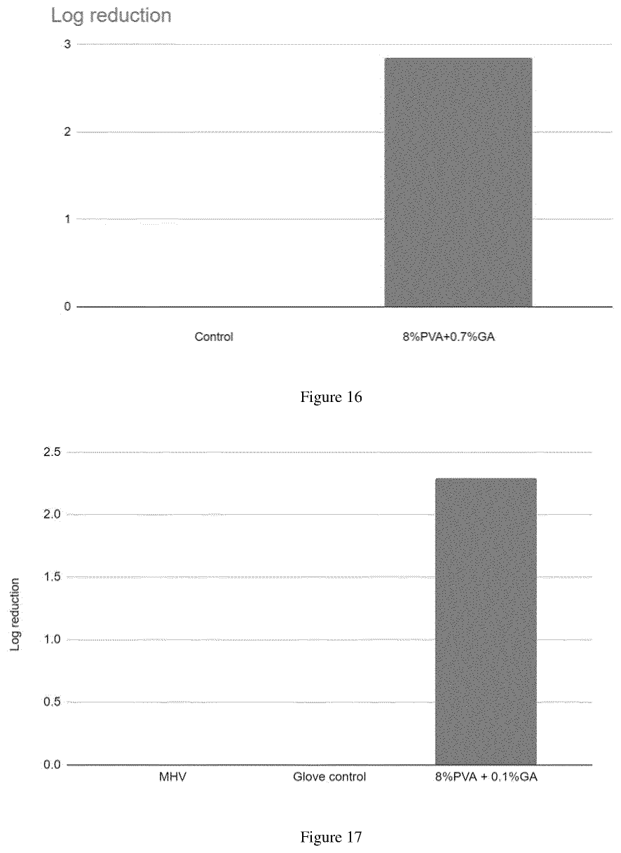

This coating demonstrated significant antiviral activity in 1 minutes of contact time in TCID50 experiments. However, toxicity on cell lines was observed for samples with a glutaraldehyde concentration higher than 0.7%. Formulations using 0.7% and 0.1% GA displayed almost 3 and 2.5 log viral reductions respectively in 1 minute contact time as shown in FIGS. 16 and 17 respectively.

### b) 8% PVA 35% Powdered Alcohol (Made With Electrolysed Water)+1% Hyaluronic Acid (HA; Made With Electrolysed Water)+(Made With Ethanol or Butanol)+0.07% CPC (Cetylpyridinium Chloride):

Synthesis method: 8.0 g of poly vinyl alcohol (PVA) purchased from (TCI, M_{w}2000 Dalton) was placed into a 200 ml beaker containing 100 ml electrolysed water with a concentration of 10000 ppm. The solution was warmed to 40° C. for an hour with stirring at 700 rpm.

To create an electrolysed water solution with a concentration of 10000 ppm HOCl, a 3.25 g tablet of Sanitab™ plus active chlorine (which has 1.7 g of active ingredient sodium dichloroisocyanurate (NaDCC)) was dissolved in 100 mL of Milli-Q water with normal stirring in a 150 ml beaker for 5 minutes at room temperature.

HOCl solution may also be obtained from electrolysing ordinary water containing dissolved salt (sodium chloride) to produce a solution of hypochlorous acid.

In the present example, HOCl has been created using Sanitab™ tablets, which use sodium dichloroisocyanurate (NaDCC) and inert compounds, and only produces hypochlorous acid when added to water. Solutions were made with strengths of 200 ppm up to 100,000 ppm and antimicrobial activity was enhanced and observed as concentration increased up to 100,000 ppm.

10 ml of the prepared PVA solution was placed in a 50 ml beaker with a magnetic bar (PTFE 35 mm×6 mm) for stirring the mixture gently at 200 rpm. Then 1% Hyaluronic acid (Aromantic) with 0.3% Ascorbic acid (Holland & Barrett), followed by 35% of powdered alcohol encapsulated with ethanol or butanol, and finally, 0.07% CPC was added to the total of the mixture. Next, pieces of gloves (Nitrile) were cut (6×6 cm dimensions) and coated by the solution prepared above. Samples were either brushed and/or sprayed and put in the oven for an hour for drying at 60°.

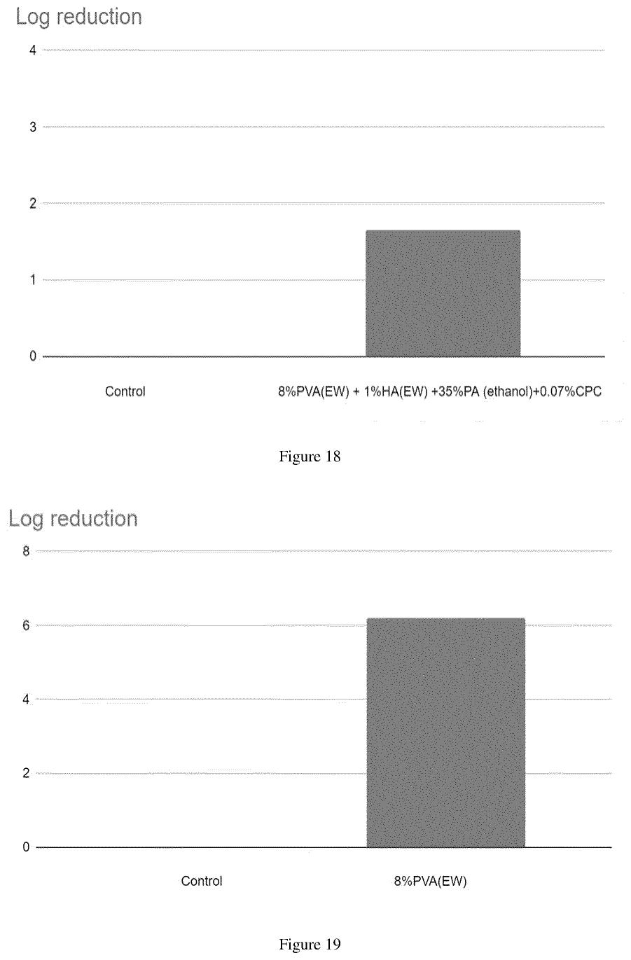

Both ethanol and butanol formulations demonstrated significant antiviral activity in 1 minutes of contact time, with a near 2 log viral reduction. The effect of powdered alcohol encapsulated with ethanol is shown in FIG. 18.

### c) 8% PVA Made With Electrolysed Water (EW):

Synthesis method: to create an electrolysed water solution with a concentration of 10000 ppm HOCl, a 3.25 g tablet of Sanitab™ plus active chlorine (which has 1.7 g of active ingredient sodium dichloroisocyanurate (NaDCC)) was dissolved in 100 mL of Milli-Q water with normal stirring in a 150 ml beaker for 5 minutes at room temperature. 8.0 g of PVA was placed into a 200 ml beaker containing 100 ml electrolysed water with a concentration of 10000 ppm. The solution was warmed to 40° C. for an hour with stirring at 700 rpm. Pieces of gloves (Nitrile) were cut (6×6 cm dimensions) and coated with the solution prepared above. Samples were either brushed and/or sprayed and put in the oven for an hour for drying at 60°.

This coating demonstrated the highest antiviral activity with a surprising 6 log viral reduction seen in 1 minute contact time as shown in FIG. 19. For comparison, FIGS. 16 and 18 show the antiviral activities of 0.7% glutaraldehyde (GA) and powdered alcohol (PA) respectively. The PA formulation was optimised with a lower PA concentration (between 1-10%, in comparison to a usual concentration of about 70% when used alone) which provided a reasonable compromise between antiviral behaviour and stability. While HA was not included in later experiments, its inclusion would be beneficial in applications such as wound dressings because it is known to facilitate wound dressing by nourishing the skin.

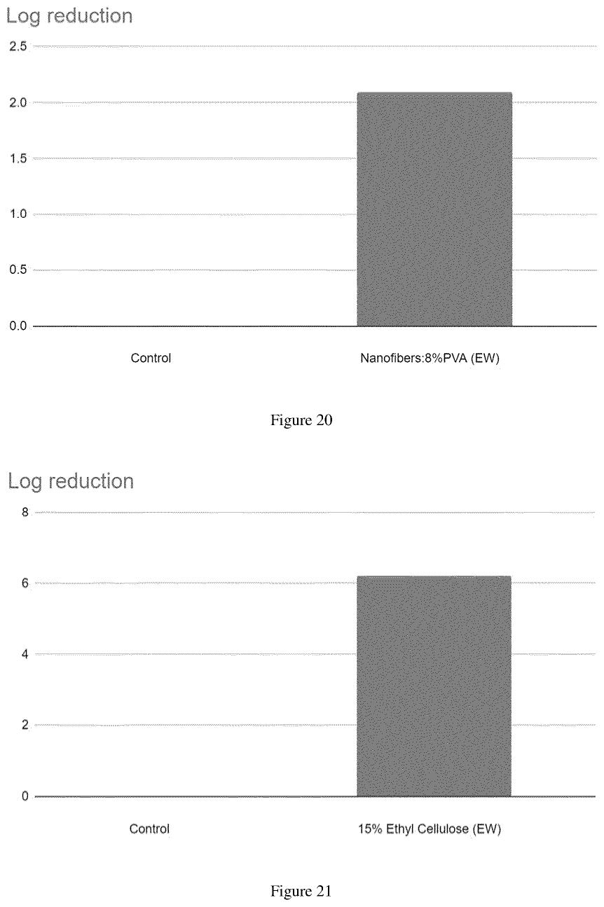

The PVA/EW samples were also electrospun to create nanofibres for application to a facemask and a similar set of results were obtained. FIG. 20 shows the antiviral activity of nanofibres made from a formulation of 8% PVA made with electrolysed water. This sample demonstrated over 2 log viral reduction in 1 minute of contact time.

The formulation and synthesis method are described below:

### 8% PVA Made With 20000 ppm HOCl Electrospun for 5 Minutes

8.0 g of poly vinyl alcohol (PVA) purchased from (TCI, M_{w}2000 Dalton) was placed into a 200 ml beaker containing 100 ml electrolysed water with a concentration of 10000 ppm. The solution was warmed to 40° C. for an hour with stirring at 700 rpm. The prepared solutions were fed from a 5 mL capacity syringe (Fisher Co., Leicestershire, United Kingdom) to a vertically orientated (25-gauge) blunt-ended metal needle via Teflon tubing. The flow rate was digitally controlled with a positive displacement syringe pump (M22 PHD 2000. Harvard Apparatus) (Edenbridge Kent, United Kingdom). The needle was connected to one electrode of a high-voltage direct-current power supply (Genvolt Co. Shropshire, UK). Typical operating regimes were flow rates of 0.2 mL/h, applied voltages of 20-30 kV, and a working distance of 15-20 cm. Electrospinning under conditions described above was performed for a duration of 5 minutes and slides were prepared for antiviral testing. In particular, nanofibres were deposited either on microscope slides or on polypropylene sheets (as used in facemasks).

### Example 13. Improving Stability of a PVA/HOCl Coating

The formulations used in the above examples were all water soluble (i.e. all individual ingredients were water soluble). This means that the coating will start dissolving once it comes into contact with water. For applications such as a facemask, since the coating is applied on the inner filter layer which is protected from touch and other external factors (e.g. water splash) by the inner and outer facemask layers, this is not a major concern. This is because even if the coating dissolves in water, the solution will deposit on the existing surrounding microstructure/microfibers of the filter layer fabric and the antiviral behaviour is anticipated to remain.

For applications such as disposable gloves it is undesirable if the coating leaches or dissolves when it comes into contact with water. Also, because there is no protection for the coating from external factors, such as water, an even higher coating stability is required because there are stronger and more touch forces involved that could more rapidly remove the coating. In order to improve the longevity and stability of the coating, a higher molecular weight PVA (130 kDa) that is less soluble compared to 2 kDa PVA was investigated. In addition, to create the formation of an even less water-soluble matrix, PVA polymers were dissolved in electrolysed water to a desired HOCl concentration and crosslinked by incubation in an oven at 130° C. for 60 min to create a large PVA network. These samples were tested only for water solubility which was significantly reduced compared to non-crosslinked PVA samples. Although solubility (leaching) was reduced some solubility was seen and so water-insoluble polymer alternatives were investigated.

To improve the stability of the coating yet further and to reduce the amount of material leach, the backbone that is used to carry and stabilise the active ingredients was replaced with water-insoluble polymers such as ethyl cellulose, methyl cellulose, cellulose acetate and cellulose acetate butyrate, poly methyl methacrylate (PMMA), poly(methyl methacrylate) (PMMA), poly (2-phenyl-2-oxazoline) (PPhOx), polyethylene oxide (PEO), poly(2-hydroxyethyl methacrylate), poly (1.2 butylene glycol) (PBG), polyacrylonitrile, polyvinyl chloride, polyvinylidene fluoride, and combinations thereof, all of which are FDA approved and have very good safety profiles compared to water-soluble polymers (e.g. PVA). This approach is technically less challenging and therefore more cost effective.

FIG. 21 shows the antiviral activity of a formulation using ethyl cellulose instead of PVA as the backbone. The results show that this coating displays significant antiviral activity, with a 6 log viral reduction seen in 1 minute of contact time. Moreover, there was significantly less solubility of the coating material and therefore lower leaching compared to the previous water-soluble (PVA backbone) samples.

The ingredients of this coating are listed below:

### 15% Ethyl Cellulose Made With Ethanol With 7000 ppm HOCl

Synthesis method: 20 g of ethyl cellulose (supplied from Fluka) was dissolved in 100 mL of absolute ethanol (Fisher) by stirring for 1 hour at 800 rpm using a magnetic stirrer. At the same time, a stock solution of 28000 ppm HOCl solution (i.e. electrolysed water) was prepared using Sanitab™ plus active chlorine as previously described. In order to create a solution suitable for coating, 2.25 mL of 20% ethyl cellulose stock solution was mixed smoothly with 0.75 mL of the 28000 ppm electrolysed water. This resulted in a solution with 15% ethyl cellulose and 7000 ppm HOCl. Nitrile gloves were then coated with either the resulting mixture/suspension or left uncoated.

### Example 14. Formulations Tested for Antiviral Activity, Safety Profile and Coating Stability

The following formulations were tested:
a) 15% ethyl cellulose with 7000 ppm, 3500 ppm, 1750 ppm, 875 ppm or 437.5 ppm HOCl;
b) 15% ethyl cellulose with 7000 ppm, 3500 ppm, 1750 ppm, 875 ppm, 437.5 ppm HOCl with 10% powdered alcohol (ethanol).

The formulations in a) were made as described in Example 13 for 15% ethyl cellulose made with ethanol with 7000 ppm HOCl but using different concentration of HOCl. Briefly, 2.25 mL of 20% ethyl cellulose stock solution was mixed smoothly with 0.75 mL of the 28000 ppm electrolysed water. This resulted in a solution with 15% ethyl cellulose and 7000 ppm HOCl. For the next sample, 2.25 ml of 20% ethyl cellulose was mixed with 0.375 ml of the 28000 ppm stock HOCl solution. Extra 0.375 ml of ethanol was then added to reach a total volume of 3 ml and the desired ethyl cellulose and HOCl concentration. The next sample was made the same way except that 0.1875 ml of 28000 ppm stock HOCl was mixed. The final ethanol volume added was 0.5625 ml. For the next sample. 0.09375 ml of 28000 ppm stock HOCl solution was mixed. The final ethanol volume was 0.65625 ml. For the final sample, 0.046875 ml of 28000 ppm stock HOCl was mixed, and the final ethanol volume was 0.703125 ml.

Samples in part b) were made exactly the same as part a) except that once the solutions in part a) were made. 10% w/v powdered alcohol was added to the solution and the final mixture stirred at 1000 rpm for 30 mins using a magnetic stirrer.

A 15% concentration of ethyl cellulose was selected because 20% is the highest concentration of ethyl cellulose that could be dissolved in ethanol.

When the water-insoluble polymer was mixed with a water-soluble coagulant mixture (calcium nitrate) directly, aggregation of ethyl cellulose (EC) was observed. This issue was overcome by preparing a colloid or suspension of micro/nano particles of ethyl cellulose in accordance with the following protocol:

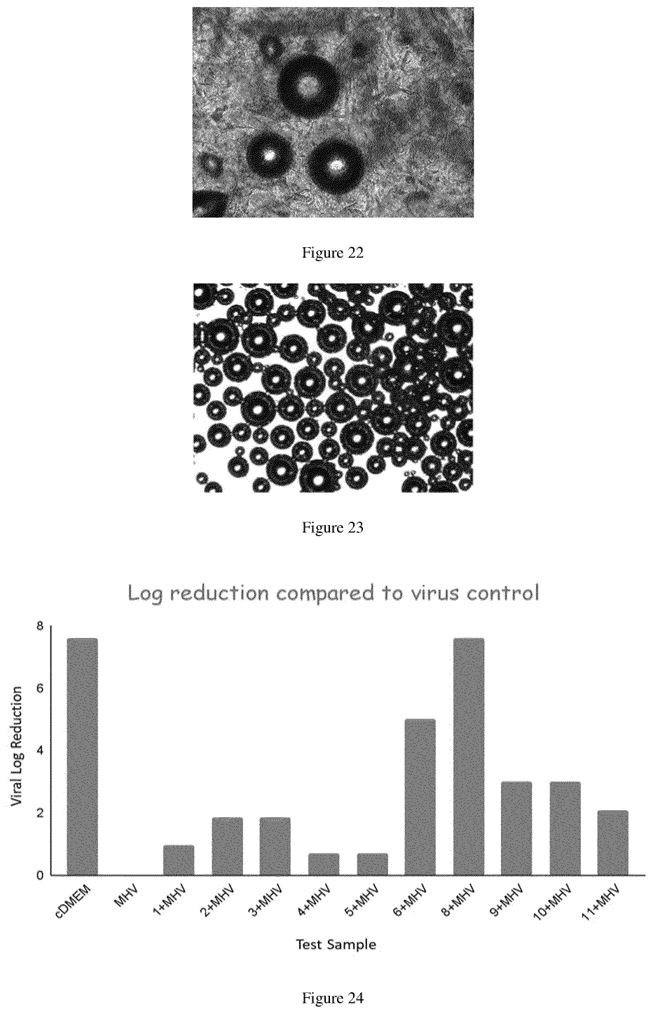

7000 ppm solution of electrolysed water was prepared by dissolving three Sanitab™ tablets in 429 ml water. Then 0.5 g of EC was dissolved in 10 ml of ethanol which was added dropwise to 10 ml of 7000 ppm electrolysed water while stirring at 1200 rmp. A white foamy suspension of EC in water was created and analysed with high resolution microscope (FIG. 22) to confirm that the mixture was in the form of a homogeneous suspension. Afterwards, 3 g Ca(NO₃)₂ and 3 g of CaCl₂ was added gradually to the above suspension and completely dissolved in the mixture. The foamy suspension of 5% EC, % 15 Ca(NO₃)₂, 15% CaCl₂ in 7000 ppm electrolysed water was formed and, again, analysed with high resolution microscope (FIG. 23) to confirm that the mixture was in the form of a homogeneous suspension.

### Example 15. Coating Procedures

Spraying is a coating technique in which a device sprays the coating material through the air onto a surface. The spray gun employs compressed air to atomise and direct the coating material particles. Air-spray gun (also called Airbrush) can be either automated or hand-held and it is typically used for covering large surfaces with a uniform coating of liquids. The air-spray gun has a nozzle, liquid basin, and air compressor. When the trigger (operation lever) is pressed, the coating liquid mixes with the compressed air stream and is released in a fine spray on the targeted surface. Coating liquid can be fed into the airbrush by gravity from a liquid reservoir sitting atop the airbrush. Gravity feed airbrushes usually require less air pressure to operate, as gravity helps assist the flow of liquid into the mixing chamber.

### A) Spray Coating:

The spraying procedure described below was used similarly and consistently for all designed formulations described above.

10 ml of each antiviral formulation was placed in the 7 cc Fluid Cup (Gravity Feed) of an ABEST Complete Professional Airbrush Compressor Kit and sprayed on the surface of samples (circular piece with radius 2 cm and area 12.56 cm² each). The area of coated samples was usually between 10 cm² and 20 cm². The distance between the spray nozzle and glove surface was fixed about 3 cm. To obtain a uniform coating, each sample was sprayed two times and each spray cycle took about 10 seconds. The weight of each sample was measured after and before spraying. An example has been provided below:

| | Sample (glove) weight | Sample (glove) weight |
|---|---|---|
| Formulation | before spraying | after spraying |
| 15% ethyl cellulose | 0.148 g | 0.188 g |
| and 1750 ppm HOCl) | | |

### B) Deep Coating

For the deep coating of samples, 3 ml of each formulation was poured into a small petri dish containing the sample (which had the same dimension as the petri dish—2 cm radius) and the sample was soaked in the formulation to ensure all surfaces of the sample were covered. The petri dish was then placed in an oven at 60° C. for 30 min to allow the solvents to evaporate slowly and a homogenised thin film to be formed on the surface of the sample. The weight of samples after and before deep coating were measured. An example is provided below:

| | Weight of glove | Weight of glove |
|---|---|---|
| | surface before | surface after |
| Formulation | deep coating (g) | deep coating (g) |
| 15% ethyl cellulose | 0.136 g | 0.672 g |
| and 1750 ppm HOCl) | | |

### C) Sequential Spraying

0.5 ml or 3 ml of 1% ethyl cellulose+0.1% Glycerol solution (as detailed above) were sprayed per 10 cm² of glove, to give a coverage of 50 μl/cm² and 300 μl/cm² respectively. 200 μl of 1% HOCl solution was then sprayed per 10 cm² to give a coverage of 20 μl/cm². These are the wet amounts and once dried, the weights differ. For example, once the water has evaporated, the HOCl solution leaves mainly HOCl salts which comprise 1% (or up to 3% as the tablet has other ingredients) of the initial weight of the solution.

Other volumes of solution are considered and encompassed, such as 0.05 ml-10 ml per 10 cm² surface area of polymer/glycerol carrier solution having 0.1-10% ethyl cellulose and 0.01-5% glycerol. An amount of 10 μl-1000 μl HOCl solution may be subsequently sprayed per 10 cm² surface area at a concentration of 0.01% to 10% w/v HOCl (equivalent to 100 to 100,000 PPM HOCl). The addition of glycerol or a plasticiser is an important part of some formulations as, without such an ingredient, the sample becomes too rigid and brittle after drying.

### Example 16. Antimicrobial Effect of Coatings

Formulations were placed in the 7 cc Fluid Cup (Gravity Feed) of an ABEST Complete Professional Airbrush Compressor Kit and sprayed on the surface of nitrile glove material. The Air Brush was connected to the “MINIAIR” single cylinder piston compressor and used for spraying the circular shaped glove samples (10 cm² surface area) with prepared solutions. Before each spraying, the air-brush pipe and nozzle were flushed and cleaned with ethanol or double distilled water depending on the solution sprayed previously. The distance between the nozzle and the surface of gloves was about 10 cm. The spraying of the surface of the gloves was done horizontally with a slight angle.

### Formulation Preparation:

1) 5% EC Control−3 ml: A stock solution of 6.67% ethyl cellulose (EC) in ethanol was prepared by dissolving 6.67 grams of EC in 100 ml of ethanol in a 200 ml beaker while stirring for 2 hours. For preparation of 5% EC control samples, the stock solution was diluted by ethanol to reach 5% EC. 3 ml of each solution were sprayed on the surface of gloves as described above and left in the oven for drying.
2) and 3) 10% and 30% glycerol control−3 ml: 10% and 30% Glycerol solutions in ethanol were prepared by dissolving 1 gram and 3 grams of glycerol in 10 ml of Ethanol respectively. 3 ml of each solution were sprayed on the surface of gloves as described above and left in the oven for drying.
4) and 5) 5% EC+0.5% glycerol control−3 ml /5% EC+1.5% glycerol control−3 ml: 500 mg or 1.5 g of glycerol were added to the 5% EC solution described in 1) above. 3 ml of each solution were sprayed on the surface of gloves as described above and left in the oven for drying.
6) and 7) 1% EC+0.1% glycerol+10 kPPM HOCl−0.5 ml /1% EC+0.3% glycerol+10 kPPM HOCl−0.5 ml: The 6.67% stock solution of EC was diluted by ethanol to reach a 1% EC solution. 100 mg or 300 mg of glycerol was added to this solution and 0.5 ml of each solution were sprayed on the surface of gloves as described above. Then 200 μl of a 10000 ppm HOCL was sprayed on the top layer of EC and then the coated gloves were put in the oven at 50° C. for 3 hours for drying.
8) and 9) 1% EC+0.1% glycerol+10 kPPM HOCl−3 ml /1% EC+0.3% glycerol+10 kPPM HOCl−3 ml: As per formulations 6) and 7) above, except that 3 ml of the EC/glycerol solution was sprayed on the surface of the gloves prior to spraying 200 μl of the 10 kPPM HOCl.
10) 5% EC+0.5% glycerol+10 Kppm HOCl−3 ml: 500 mg of glycerol was added to the 5% EC solution described above and 3 ml of this solution was sprayed as described above. Then, 200 μl of a 10000 ppm HOCl was sprayed on the top layer of EC and then the coated gloves were put in the oven at 50° C. for 3 hours for drying.
11) 5% EC+1.5% glycerol+10 Kppm HOCl−0.5 ml: 1.5 g of glycerol was added to the 5% EC solution described above and 0.5 ml of this solution was sprayed as described above. Then 200 μl of a 10000 ppm HOCL was sprayed on the top layer of EC and then the coated gloves were put in the oven at 50° C. for 3 hours for drying.

As can be seen from FIG. 24, formulations 6 and 8 (1% EC+0.1% glycerol+10 kPPM HOCl 0.5 ml and 3 ml respectively) demonstrated superior antiviral action with approximately 5 and 7 log virus reduction in a 1 minute contact time.

Formulation number 6 above was made in two replicates and kept at room temperature (25° C.) for 3 weeks. Light condition samples were kept inside a petri dish without any other cover, whereas the dark condition samples were kept in a petri dish and then placed in a cardboard box where no light could pass through.

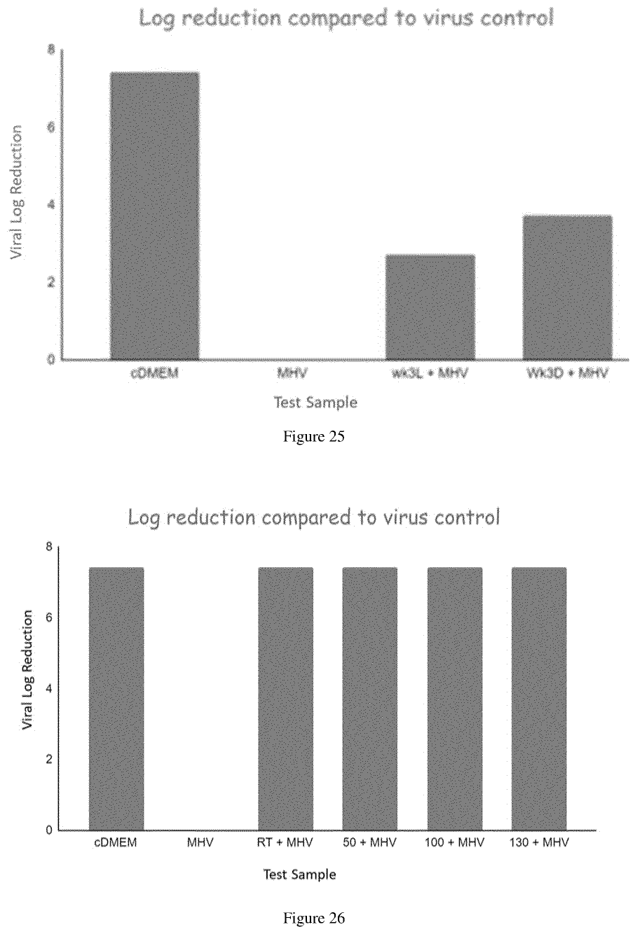

As shown in FIG. 25, these storage stability experiments demonstrate the antiviral activity of the samples after 3 weeks of storage in either light (L) or dark conditions (D). The samples demonstrated more than 3 and 4 log virus reduction respectively with a 1 minute contact time.

Temperature stability studies were performed to test the stability of HOCl at high temperatures, particularly those temperatures used for manufacture of articles such as nitrile gloves. Circular shaped glove samples (10 cm² surface area) were fixed on petri dishes using double sided tape. Then 200 μl of a 10.000 ppm HOCl was sprayed directly on the surface of four coated samples and the samples were exposed to room temperature (25° C.; RT) and temperatures of 50° C. 100° C. 130° C. for 30 minutes. Hot plates were used to heat up the samples. Samples were kept in a petri dish covered with aluminium foil overnight prior to antiviral testing.

### Antiviral Activity was Tested as Follows:

The samples were tested for their effectiveness in inactivating the murine coronavirus (MHV) in 1 minute of contact time using L929 cells. L929 cells were seeded at a concentration of 5×10⁵ cells/ml in 100 μl volume in a 96-well format.

The neat virus stock was used (MOI (multiplicity of infection) of 10 for 10000 cells). 20 μl of MHV was placed on each sample and incubated for 1 minute of contact time at room temperature (25° C).

Serial dilutions of the treated virus were then carried out. 20 μl of treated virus was added to the second row from the bottom of the 96-well plate of the dilutions and mixed well. Then, 20 μl of this second row dilution was added to the next row above. The process of mixing and transferring to the next row was repeated for eight concentrations whilst changing pipette tips each time. 20 μl of serially diluted MHV or control from the plate was directly transferred onto cells (‘test plate’) in quadruplicate and mixed by pipetting gently. Cells were then incubated for 48 hours. Cell infection phenotype as cell death and cytopathic effect (CPE) was observed under a benchtop light microscope (20× magnification) at 48 hours post infection (hpi) intervals.

As illustrated in FIG. 26, all experimental formulations displayed excellent antiviral activity with no reduction in activity.

Antibacterial studies were also performed to investigate the antimicrobial effect a formulation of 1% EC, 10 kppm HOCl, 0.1% glycerol against Staphylococcus aureus carried out in accordance with ASTM D7907 (Standard Test Methods for Determination of Bactericidal Efficacy on the Surface of Medical Examination Gloves).

Bacteria Staphylococcus aureus NCTC 10788 were streaked on Oxoid Horse blood agar plates (Fisher scientific—PB0114A) and incubated for 24 hours at 37° C. prior to testing.

For anti-bacterial testing, cell suspensions were made with Phosphate Buffer saline (PBS) and diluted with neutralisation buffer (NB) containing Mueller Hinton Oxoid Broth (21 g/L) (Fisher scientific—CM0405B) with 0.7% Arabic gum. Bacterial suspensions were spread on Mueller Hinton Agar (38 g/L).

With a sterile loop, 5-10 colonies were mixed into 5 ml of sterile PBS. Suspension optical density was measured at 625 nm and adjusted to 0.5 McFarland standard (OD625 should read 0.08-0.13). The suspension was diluted by half with Mueller Hinton Broth (MHB) to give a 20 μl inoculum containing 10⁶ CFU. A 1 in 2 dilution with neutralisation buffer (NB) was also made for control measures. In replicate (n=3), 1 ml of a 1/1000 dilution of both the MHB and NB bacteria suspension were plated on Mueller Hinton agar (MHA) to confirm initial CFU/ml, along with a sample of undiluted penicillin as a control measure. A 20 μl sample of the MHB bacterial suspension was placed on a control and test sample and a glass coverslip placed on top with sterile tweezers. Samples were left for 0, 1, 2 and 5 minutes (time periods can be modified up to 30 minutes) and then transferred into 10 ml of neutralisation buffer and inverted fifteen times to neutralise the formula and re-suspend any viable bacteria cells. 1 ml of an undiluted and 1/10 dilution of each sample was spread on agar plates with replicates (n=3) and incubated at 37° C. for 24 hours. Colonies were counted manually and the average Log10 of the CFU/ml was calculated. The log reduction was calculated by subtracting the Log number of colonies from the test sample from the control sample.

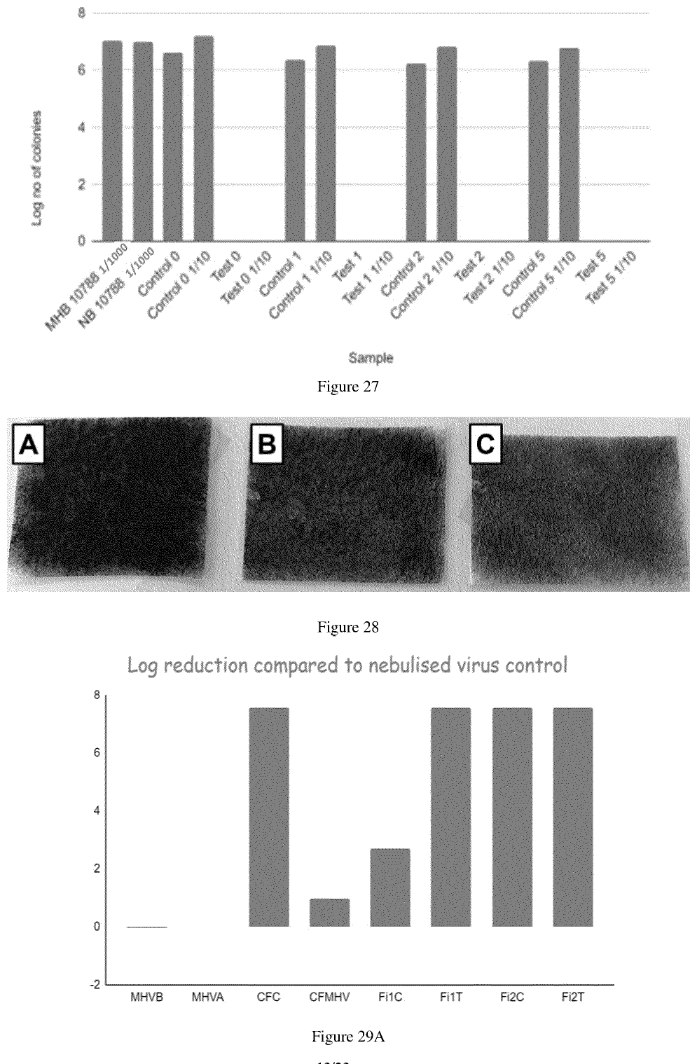

As can be seen in FIG. 27, excellent results were obtained at all contact time points, with complete inhibition of bacteria being seen (more than 6 log reduction in the number of bacterial colonies).

### Example 17. Effectiveness of Antiviral Spray-Coated Air Filters

Traditional HEPA (high efficiency particulate air) filters do not have the ability to kill trapped pathogens and hence they pose a potential risk of redistribution of these pathogens into the environment. In the following examples, antiviral and antibacterial formulations described herein were used to produce a coating suitable for application onto HEPA filters to add virus and bacteria killing functionality. Of importance was to produce minimal impact on the air resistance of the filters to minimise the air pressure drop across the filter. The antimicrobial filters developed in this example can be retrofitted to a wide range of existing air purification and ventilation systems with no change in the system.

### Spray Coating

### Coating Materials Sprayed on Nonwoven Fabric Substrates:

Polyethylene oxide (PEO; MW:400K), Sodium-Carboxymethyl Cellulose (Na-CMC; MW: 90K, 250K, and 750k), Hydroxy Ethyl Cellulose (HEC) and Hydroxy Propyl Methyl Cellulose (HPMC) as polymers and Glutaraldehyde (GA) and HOCl as an active agent were used in the preparation of the coating liquid.

### Fabrication of Coated Filters Via Spraying Technique:

With a manual operation process, the air-gun sprayer was held by a skilled operator, about 3 to 5 cm from a nonwoven substrate and moved left and right over the surface, each stroke overlapping the previous, to ensure a continuous coat. The flow rate of the coating liquid was controlled by an O-ring flow rate adjuster. The object being coated was usually placed on a flat surface to ensure overall equal coverage of all sides.

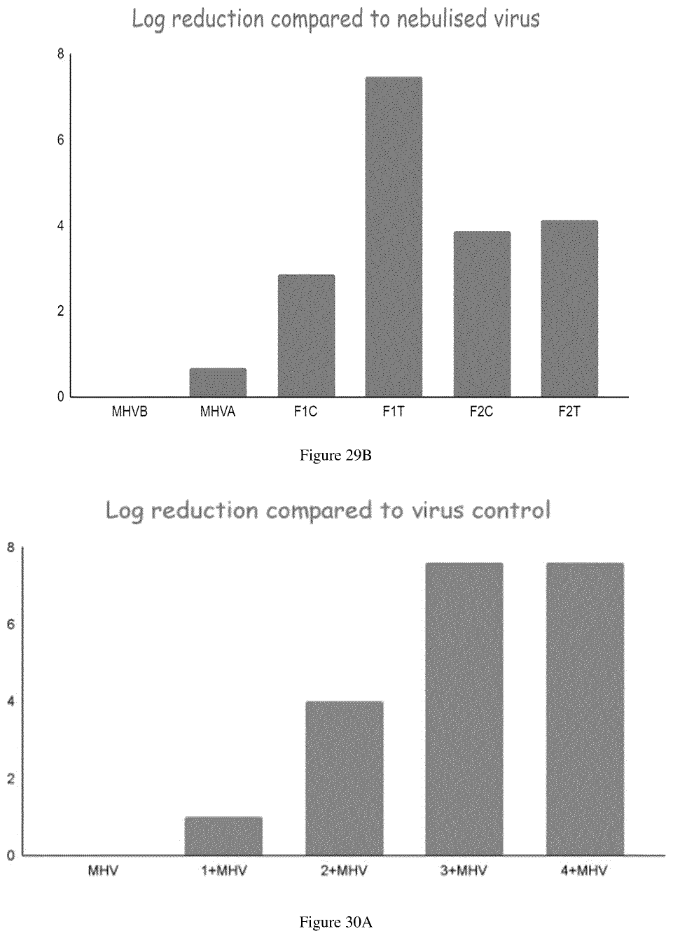

FIG. 28 shows the effect of spraying a formulation of 1.6 wt. % Na-CMC, 0.9 wt. % GA, and 2 wt. % MB on HEPA filters at coating liquid deposition quantities of 200 μl (FIG. 28A), 100 μl (FIG. 28B), and 50 μl (FIG. 28c). MB was added as a visual identifier of coated filters.

### Antiviral Test Method

The antiviral test method used in this example was composed of two main sections: (i) virus (Murine Hepatitis Virus (MHV)) nebulisation and exposure to H13 HEPA filters provided by Vent-axia®, and (ii) testing of the treated samples according to ISO 18184 (determination of antiviral activity of textile products). All experiments were carried out in a Biological Level 2 Safety laboratory.

### i) Antiviral Airborne Test: Virus Nebulisation and Exposure to a Filter Material:

A test chamber containing two layers of filter material was connected to a nebuliser from one end and an aspirator from the other end. The nebuliser produced virus aerosols (and fed them into the test chamber where an air pressure difference was created by the aspirator, allowing the air to flow through the layers of filter.

Two layers of filter material were positioned sequentially in a vertical orientation (resting on the depth of the material) with a gap between that was equal to the depth of each filter. Each filter had a coated half and a non-coated half, with the coating facing the direction of air flow through the test chamber. Alignment of the coated and uncoated portions was such that air that flowed through the uncoated portion of the first filter also flowed through the uncoated portion of the second filter.

### ii) Antiviral Droplet Test: Viral Infectivity Test of Filter Samples:

Once the virus nebulisation had been completed, the filter samples were taken out and tested using cell variability assays according to ISO 18184. In brief, the recovered samples were placed in falcon tubes containing 5 ml of cDMEM solution (cell culture medium). Appropriate positive and negative controls were tested in the experiment which included untreated filter material not exposed to nebulised virus and untreated filter material directly exposed to virus droplets. Serial dilution of the treated samples was then carried out in a dilution plate and samples were transferred into 96-well plates containing L929 mammalian cells and incubated for 48 hours. The viral infectivity of the virus on the cells was then observed under the microscope and quantified to TCID50/ml measurement using the Reed-Muench-Lindenbach calculator.

Detailed information about the cell viability assay protocol are as follows.

### Day 1—Plating Cells:

L929 cells were counted and resuspend at 5×10⁵ cells/ml in complete DMEM (cDMEM). 100 μl cells in suspension were added to each well (50.000 cells per well) in a 96-well plate which was incubated overnight (˜18 h) at 37° C. to produce ˜100.000 cells per well for infection.

### Day 2—Treatment and Infection:

200 μl virus was added to each sample and incubated for the duration of the required contact time (1 min or 5 min). 5 ml cDMEM was then added to each tube and the tubes vortexed 5 secs. Addition of cDMEM was repeated a further four times. 250 μl of treated virus was then added to the 1st (bottom) row of a 96-well plate. Serial dilutions were then carried out by adding 25 μl of treated virus to the second bottom row of the dilutions, mixing well, then taking 25 μl of the 2nd bottom row and add it to the next row, repeating the mixing and transferring for the next row for eight concentrations, changing pipette tips between each mixing. This resulted in a 5 fold dilution.

20 μl media was then removed from cells and added to each well. 20 μl of serially diluted MHV or control from plate was added directly onto cells+media (‘test plate’) in quadruplicate (will be 40 μl per well when finished) and mixed by pipetting gently. After one hour, 50 μl media was added to each well and the plate incubated for 48 hours.

### Day 4/5—Check for Cell Death:

An inverted microscope was used to check whether any cells in the plate were dying. If cells in a well are all dead, this was counted as a positive well. When there was a clear demarcation between wells containing all dead cells and those where the cell monolayer was intact, the TCID50 was calculated using a Reed-Muench Calculator

### Pressure Drop Measurement: Measuring Filter Resistance:

The pressure drop across the HEPA filter media with and without an antiviral coating was measured at the face velocity range of 0-12 m/s. The pressure drop was measured using the probe of area 12.6 mm². The pressure drop across the reference HEPA filter was 3.5-40 mbar at face velocity of 2.66 m/s to 12 m/s, respectively. Measurements were performed at four different locations. After spray coating, the antiviral filter was left to dry overnight.

### Anti-Bacterial Droplet Test:

Method adapted from ASTM D7907 Standard Test Methods for Determination of Bactericidal Efficacy on the Surface of Medical Examination Gloves.

### Bacteria Strains:

Staphylococcus aureus NCTC 10788 (hereafter 10788) re-streaked on Horse blood agar plates Oxoid (Fisher scientific—PB0114A) and incubated for 24 hours at 37° C. prior to testing.

### Reagents:

For bacteria revival bacteria is streaked on Horse blood agar plates Oxoid (Fisher scientific—PB0114A) and bacteria colony growth during testing is cultured on Mueller Hinton Agar—Oxoid (38 g/L).

Phosphate Buffer saline (PBS) and Mueller Hinton Broth (MHB)—Oxoid (21 g/L) (Fisher scientific—CM0405B) are used to create bacteria inoculum.

Neutralisation buffer (NB) contains Mueller Hinton Broth—Oxoid (21 g/L) (Fisher scientific—CM0405B) with 0.7% Arabic gum.

### Culturing Conditions:

To revive Staphylococcus aureus NCTC 10788 from cryogenic storage bacteria was re-streaked on Horse blood agar plates and incubated for 24 hours at 37° C. prior to testing. After testing all samples were spread on Mueller Hinton Agar and incubated for 24 hours at 37° C. prior to counting colonies.

### Method

With a sterile loop, 5-10 colonies were mixed into 5 ml of sterile PBS. The suspension optical density was measured at 625 nm and adjusted to 0.5 McFarland standard (OD625 should read 0.08-0.13) to give 10⁸ CFU/mL. The suspension was diluted 1 in 2 with Mueller Hinton Broth to give a 20 μL inoculum containing 10⁶ CFU for testing. A 1 in 2 dilution with neutralisation buffer (NB) was also made for control measures to ensure the NB showed no inhibition to the cells. In replicate (n=3) 1 mL of a 1/1000 dilution of both the MHB+10788 and NB+10788 bacteria suspensions were spread on Mueller Hinton agar (MHA) to confirm initial CFU/mL, along with a neat sample with penicillin as a control measure to confirm antibiotic sensitivity.

A 20 μl sample of the MHB bacterial suspension (MHB+10788) was placed on a control (HEPA filter only) and test sample (HEPA filter plus formulation) and a glass coverslip placed on top with sterile tweezers. Samples were left for 0, 1, 5 and 15 minutes (time points can be modified up to 30 minutes) and then transferred into 10 ml of neutralisation buffer and inverted 15 times to neutralise the formulation and re-suspend any viable bacteria cells. 1 mL of a neat and 1/10 dilution of each sample was spread on Mueller Hinton agar plates in replicate and incubated at 37° C. for 24 hours. Colonies were counted manually, and the average Log 10 of the CFU/mL was calculated. The log reduction was calculated by subtracting the Log number of colonies from the test sample from the control sample from each time point.

### Results

### Antiviral Airborne Test:

In a first experiment and as illustrated in FIG. 29A, a virus count of 7×10⁴ TCID50/ml was observed on the untreated side of the first filter in the series (filter 1; Fi1C). No infective virus was observed on the treated side of filter 1 (Fi1T), the non-treated side of filter 2 (Fi2C), or the treated side of filter 2 (Fi2T). These observations demonstrate that, compared to the non-treated control (MHVB (MHV before nebulisation), MHVA (MHV after nebulisation)), there was a virus reduction of more than 4 logs (>99.99%) in the treated sample (CFC). As expected, no infective virus was detected on filter 2, which indicates the effective filtration efficiency of the HEPA filter used.

These observations indicate that all the virus particles captured by a commercial HEPA filter were inactivated by a coating sprayed with a formulation of 2% PEO and 2% GA, whereby GA was the active agent and PEO was the polymer carrier.

In a repeat experiment, shown in FIG. 29B, no virus was seen on the test side of filter 1 (i.e. the spray coated side; F1T) while virus was detected on the control side (F1C, F2C). Unlike the first experiment, virus was observed on the test side of filter 2 (F2T) suggesting that viruses could somehow escape either through the first filter layer or around the sides of the first filter.

### Antiviral Droplet Test:

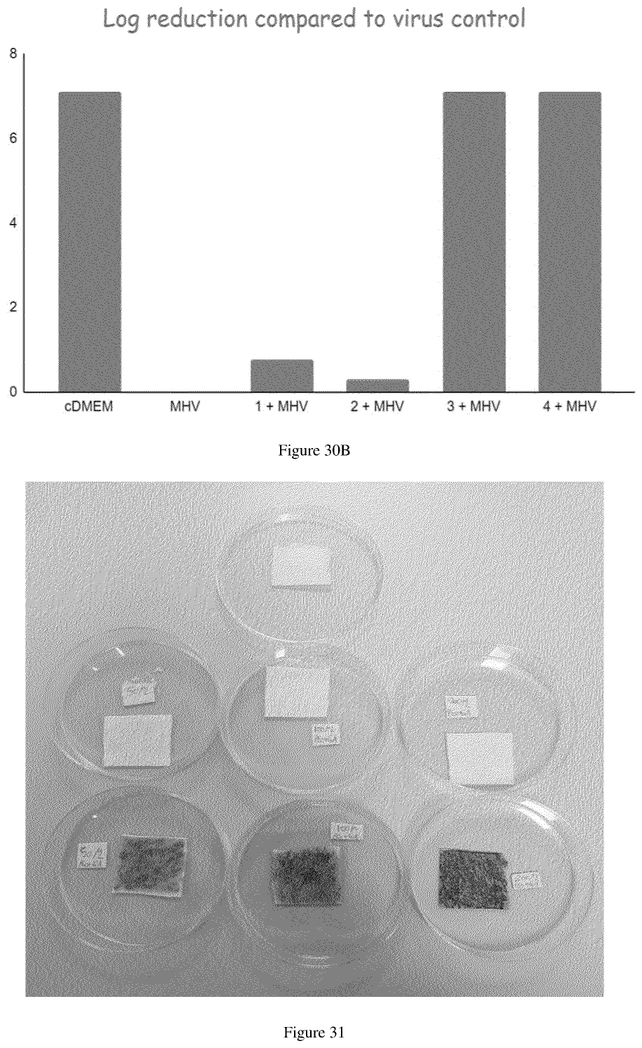

As illustrated in FIG. 30A, droplet antiviral testing on the samples showed that, compared to the uncoated HEPA filter (HEPA; 1+MHV), all coated samples showed excellent antiviral activity.

To verify the results of this experiment, particularly regarding the antiviral effect of a PEO-only coating, the same batch of the coated filters were tested in week 2 post-spray coating. When looking at the fresh samples, no antiviral efficacy was observed in PEO-only samples, in contrast to the results of the first experiment. As a result, it was concluded that the antiviral efficacy observed in experiment 1 must have been an experimental error. As expected, fresh samples 3 and 4 showed excellent antiviral efficacy (FIG. 30B) which was consistent with subsequent stability experiments (see below).

### Filter Resistance Test:

The aim of this experiment was to find the optimal amount of coating solution based on a trade-off between pressure drop and antiviral effect. The pressure drop introduced to the HEPA filter when spray coated a PEO+GA formulation was measured. The volume of the liquid solution sprayed on the filters was either 50 μl or 100 μl for a filter area of 6 cm² (8.3 and 16.7 μl/cm²).

Spray solution: 2 wt % PEO+2 wt % GA in water

Samples: The following seven spray-coated samples were prepared, as shown in FIG. 31:
1. Control HEPA Filter.
2. 50 μl PEO+GA
3. 50 μl PEO+GA+Blue Colour (methylene blue (MB))
4. 100 μl PEO+GA
5. 100 μl PEO+GA+MB
6. 200 μl PEO+GA
7. 200 μl PEO+GA+MB

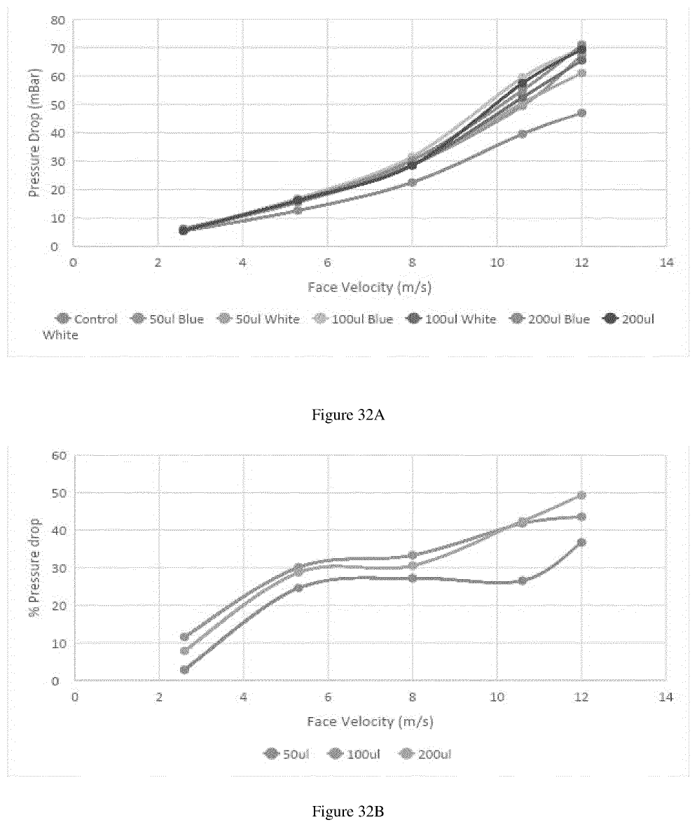

Pressure drop was measured at four different points on the filter and the values given in Table 2 below show the average pressure drop across the filter. As illustrated in FIG. 32, minimal pressure drop values were observed when 50 μl and 100 μl (8.3 and 16.7 μl/cm²) coatings were used. Compared to the control filter, the increased pressure resistance was within 10 mBar for these two volumes which is within the error of the experiment setup.

TABLE 2

| Flow Rate | | | 50 μl- | 50 μl- | 100 μl- | 100 μl- | 200 μl- | 200 μl- |
|---|---|---|---|---|---|---|---|---|
| Without filter | Velocity | Control | Blue | White | Blue | White | Blue | White |
| 1/m | m/s | mBar | mBar | mBar | mBar | mBar | mBar | mBar |
| 2 | 2.6 | 5.4 | 5.35 | 5.75 | 5.9 | 6.15 | 6.1 | 5.55 |
| 4 | 5.3 | 12.6 | 15.95 | 15.45 | 16.9 | 15.9 | 16.2 | 16.25 |
| 6 | 8 | 22.5 | 28.75 | 28.5 | 31.5 | 28.5 | 30.25 | 28.5 |
| 8 | 10.6 | 39.5 | 49.5 | 50.5 | 59.5 | 52.5 | 55 | 57.5 |
| 9 | 12 | 47 | 67.5 | 61 | 69.5 | 65.5 | 71 | 69.3 |

These studies demonstrate the effectiveness of formulations of the present invention on the nebulised virus particles both in terms of antiviral effect and the introduced pressure drop. Due to these promising results, the formulation was optimised based on four main parameters which were: safety of the chemical solution, antiviral effectiveness and longevity, and pressure drop in the system.

### Example 18. Polymer Stability

The longevity of antiviral action of a 2% PEO+2% GA formulation was investigated by spray coating ten HEPA filters with the following coatings in week 1:
1. HEPA only
2. 2% PEO only
3. 2% GA only
4. 2% GA+2% PEO

One of each sample was tested each week using a droplet test (fabric) protocol in which a volume of 250 μl was sprayed to a 12 cm² filter substrate (20.8 μl/cm²). Results are shown in FIG. 30B from which it can clearly be seen that all samples have excellent antiviral effect at week 2, which confirmed that the formulation is still effective in week 2 post synthesis with more than 4log of virus reduction.

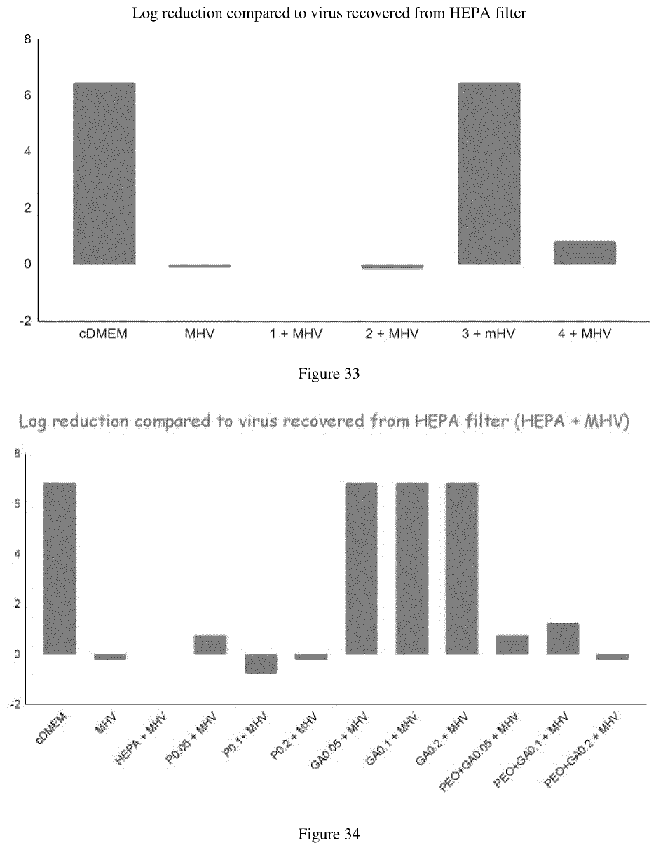

The same batch of samples was tested for antiviral efficacy in week 3 using the same protocol (ISO 18184, contact time of 5 min). Surprisingly, sample 4 (PEO+GA) was seen to have reduced antiviral effect compared to the results of week 2, while sample 3 (GA only) maintained the antiviral efficacy (more than 4 log compared with control) (FIG. 33).

The PEO+GA samples were also tested 5 weeks post-spraying to investigate further the results observed at week 3. As seen in FIG. 34, no deterioration on the antiviral effect of the GA only sample was seen but the GA+PEO formulation showed more than 2 log reduction, which was higher than the same results obtained in week 3, which could be due to sample variability. These results also confirmed that the GA-only formulation has the highest stability.

### Example 19. Antibacterial Effect of Formulations

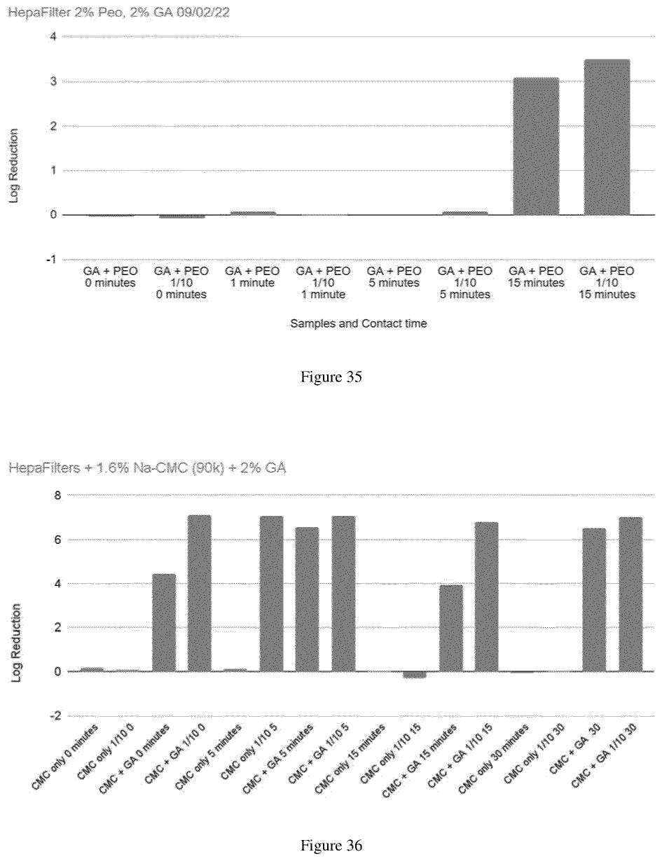

The antibacterial tests (FIG. 35) showed that the filter coated with a formulation of 2% PEO+2% GA significantly inhibited bacterial growth after a contact time of 15 min (more than 3log).

Antibacterial tests as set out above were also carried using S. aureus bacteria on filters coated with a coating formulations of 2% PEO+2% GA.

As shown in FIG. 36, more than 4 log reductions of bacteria were seen for a coating formulation of CMC (90k)+2% GA (6% or Na-CMC (90 kDa) 1.6%+GA 2% (shown as CMC+GA in the figure)) compared to control filters even at time point 0 (less than 10 seconds). Similar results were observed at 5, 10 and 15 minute time points.

### Example 20. Alternative Polymers to PEO

In this experiment, the antiviral effect of GA when mixed with sodium carboxymethylcellulose (Na-CMC) (as an alternative to PEO) at different molecular weights, or hydroxyethylcellulose (HEC), was tested in the antiviral droplet test:
1. 1.6% CMC (90 kDa)
2. 1.6% CMC (90 kDa)+2% GA
3. 1.6% CMC (250 kDa)
4. 1.6% CMC (250 kDa)+2% GA
5. 1.6% CMC (700 kDa)
6. 1.6% CMC (700 kDa)+2% GA
7. HEC
8. HEC+2% GA

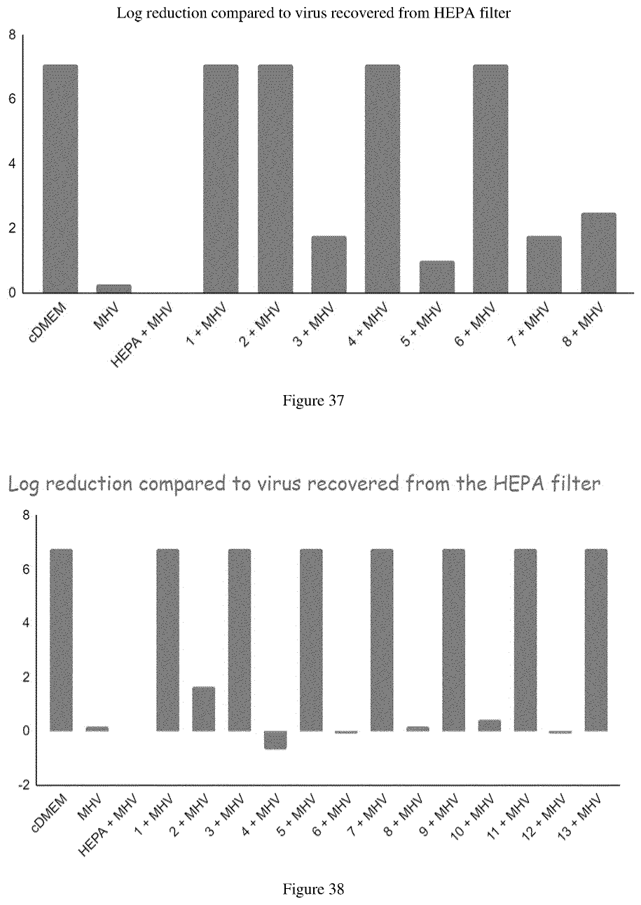

It was observed that CMC+GA produced excellent antiviral effects at all molecular weights (FIG. 37). No effect was seen with HEC and so the CMC+GA experiments were repeated using a larger variation of CMC with regards to the substitution number to find an optimal molecular weight and substitution number.

In the previous experiment, it was observed that all Na-CMC formulations produced maximal antiviral activity (more than 6 log). As a result, a range of different CMC+GA formulations were tested to investigate the effect of substitution number of CMC on the antiviral activity, together with hydroxypropylmethylcellulose (HPMC) as an alternative polymer.
1. 2% GA only
2. 2% Methylene Blue (MB) only
3. 1.6% Na-CMC (90 kDa)+2% GA+2% MB
4. 1.6% Na-CMC (90 kDa)
5. 1.6% Na-CMC (90 kDa)+2% GA
6. 1.3% Na-CMC (250 kDa)−substitution number (SN) 0.7
7. 1.3% Na-CMC (250 kDa)−SN 0.7+2% GA
8. 1.3% Na-CMC (250 kDa)−SN 1.2
9. 1.3% Na-CMC (250 kDa)−SN 1.2+2% GA
10. 0.6% Na-CMC (750 kDa)
11. 0.6% Na-CMC (750 kDa)+2% GA
12. 1% HPMC
13. 1% HMPC+2% GA

In this experiment, excellent antiviral effect was observed at all substitution numbers (SN) of CMC when CMC was mixed with 2% GA (FIG. 38). Based on these observations, it was concluded that the SN of the CMC did not have any effect on the antiviral efficacy.

### Example 21. Antiviral Effectiveness of GA at a Concentration of 0.9% and at Different Sprayed Volumes

Theoretical analysis was carried out to prepare a safety data sheet for the coating formulations, and a safety limit of 0.9% GA concentration was selected on the basis that all safety hazards would be in categories 4 or above. The antiviral effect of a reduced GA concentration was then investigated. In particular, the antiviral activity, as well as the pressure drop, on the coated filters was investigated using three different coating volumes to determine with the best trade off in terms of antiviral activity and pressure resistance introduced by CMC+0.9% GA solution. These experiments were performed with a 1 min contact time between the virus and the filter substrates.

The following formulations were spray coated on 12 cm² HEPA filter substrates (4.16, 8.3 and 16.7 μl/cm²):
1. 200 μl 1.6% Na-CMC (90k)
2. 50 μl 0.9% GA
3. 100 μl 0.9% GA
4. 200 μl 0.9% GA
5. 50 μl 1.6% Na-CMC (90K0+0.9% GA+2% MB
6. 100 μl 1.6% Na-CMC (90K0+0.9% GA+2% MB
7. 200 μl 1.6% Na-CMC (90K0+0.9% GA+2% MB

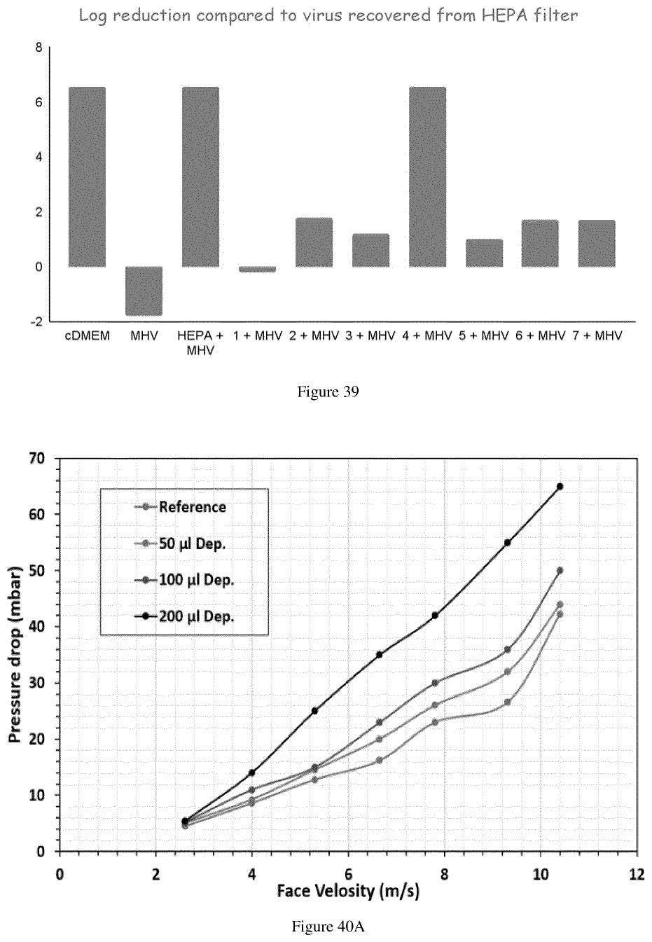

The antiviral droplet test results shown in FIG. 39 indicate that 200 μl (16.7 μl/cm²) GA 0.9% only solution produces the highest possible antiviral activity when compared to other formulations. All other formulations produced less than 2 log of reduction compared to the uncoated HEPA filter.

### Example 22. Pressure-Drop Introduced Using 50, 100 and 200 μl Solutions of 0.9% GA

The same formulations used in Example 21 were further investigated to test the pressure drop produced by these formulations. The volumes of sprayed formulation were 50, 100 and 200 μl solutions on 12 cm² filter substrates (4.16, 8.3 and 16.7 μl/cm²). FIGS. 40A and 40B illustrate the percentage pressure drop as a function of face velocity for different deposition quantity of (50, 100, and 200 μl). These results showed that 50 μl and 100 μl (4.6 and 8.3 μl/cm²) (at face velocities less than 6 m/s) sprayed volumes showed satisfactory performance.

These results show that that a GA-only solution is capable of producing the highest amount of antiviral effect when the GA concentration is 0.9% and the volume of sprayed solution is 200 μl i.e. the highest amount of introduced pressure drop.

### Example 23. Effectiveness of HOCl to Enhance Antiviral Activity of 0.9% GA

In this experiment, HOCl was added to and mixed with a 0.9% GA solution at volumes of 50 and 100 μl (4.6 and 8.3 μl/cm²) to assess any synergistic antiviral effect. The following formulations were tested:
HEPA filter only
Filter+20 kppm HOCL
Filter+0.9% GA
Filter+0.9% GA+20 kppm HOCL
Filter+1.6% Na-CMC (90 kDa)
Filter+20 kppm HOCL+0.9% GA+1.6% Na-CMC (90 kDa)
Filter+20 kppm HOCL+0.9% GA+1.6% Na-CMC (90 kDa)+2% MB

All samples were tested in the antiviral droplet test at volumes of 50 μl and 100 μl.

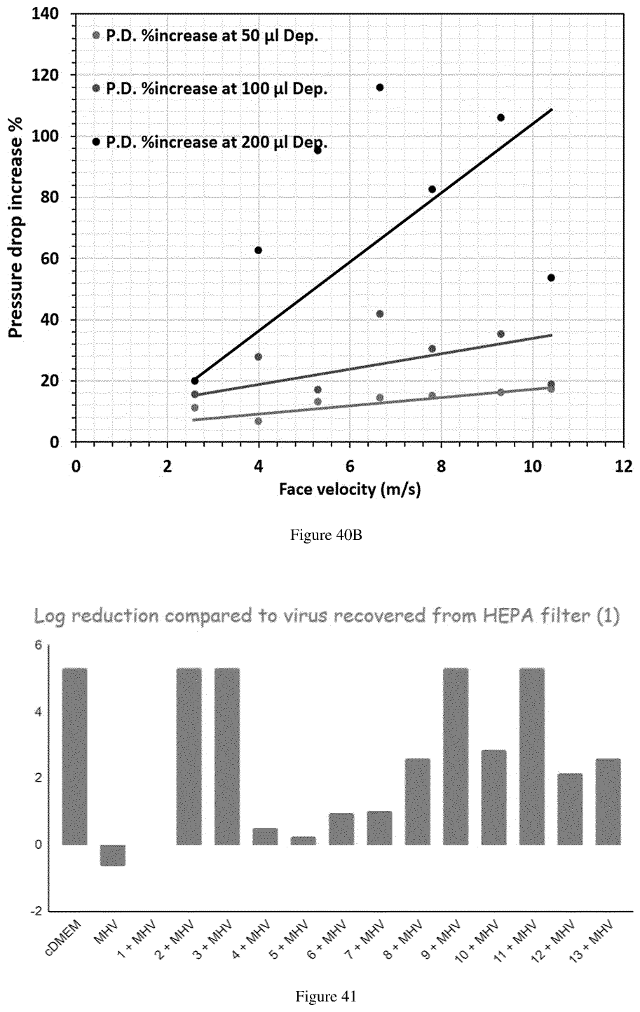

As shown in FIG. 41, the addition of HOCl increased the antiviral activity of the 0.9% GA formulation. More activity was observed at 100 μl liquid, compared to 50 μl, as expected due to the larger volume applied.

### Example 24. Pressure Drop Test at 50 μl (4.6 μl per cm²) Vs 100 μl (8.3 μl per cm²)

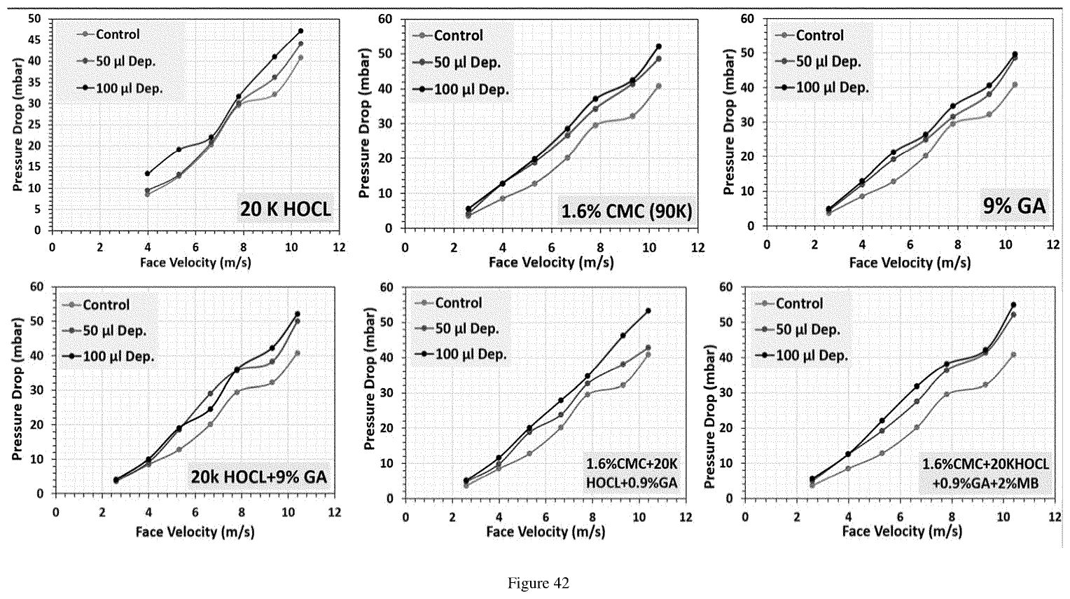

In this experiment, the pressure drop produced by the formulations tested in Example 23 were tested to find the difference in pressure drop between spray volumes of 50 μl and 100 μl volume. The results shown in FIG. 42 demonstrate that there is no significant difference in pressure drop introduced by 50 μl and 100 μl volumes of coating in the samples at the 3-5 face velocity range, which is the range used in the conventional air purifiers.

### Example 25. Stability of 1.6% CMC (90 kDa)+2% GA Solution After 3 Weeks

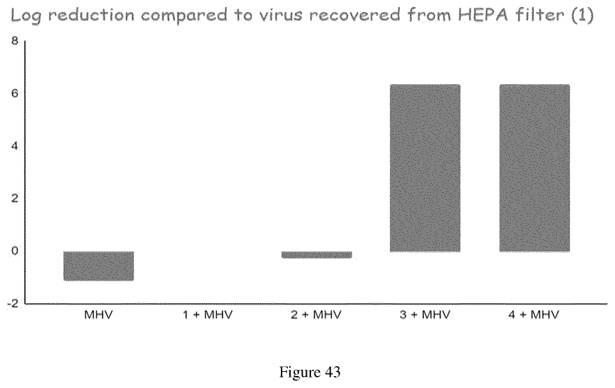

The stability of the 1.6% CMC+GA 2% solution 3 weeks post spray coating using the antiviral droplet test. As is shown in FIG. 43, coating formulations of 2% GA and 1.6% CMC+2% GA were both as stable at week 3 post coating as they were in week 1, with more than 6 log reduction compared with the titre of the virus recovered from the uncoated filter.

The above examples demonstrate that water-soluble adhesives are viable to stabilise and adhere a powdered alcohol formulation onto a substrate. While Xanthan gum is viable, PVA provides better and more stable results. The texture of the resulting coating can also be altered and improved to move from a grainy coating to a rubbery, gel-like formulations. In addition, the examples show that other active agents, as well as alcohol, are viable in an antiviral/antimicrobial coating.

Formulations using glutaraldehyde (GA) demonstrated high antiviral behaviour, but toxicity was demonstrated at concentrations higher than 0.7%. Generally speaking, GA is not the safest ingredient as it is a chemical disinfectant and non-organic. Safer alternatives were formulations using powdered alcohol and HOCl. The results also indicated that HOCl is a very effective antimicrobial agent with an even stronger antiviral activity than powdered alcohol although, at high concentrations of HOCl, cell death and toxicity were observed.

1. An antimicrobial and/or antiviral coating comprising:
i) at least one non-biological antimicrobial and/or antiviral agent; and
ii) a polymer carrier.

2. The coating of claim 1, wherein the at least one non-biological antimicrobial and/or antiviral agent is present in the coating in an amount of between about 0.01% and about 40%, preferably between about 0.01% and about 10%, more preferably 0.01% to 5%

3. (canceled)

4. The coating of claim 1, wherein the at least one non-biological antimicrobial and/or antiviral agent is present in the coating in an amount of between about 5% and about 15%.

5. The coating of claim 1, wherein the at least one non-biological antimicrobial and/or antiviral agent is present in the coating in an amount of between about 25% and about 40%.

6. The coating of claim 1, wherein the at least one non-biological antimicrobial and/or antiviral agent is selected from: a disinfectant, a cleaning and/or sanitising, agent a bleach, an alcohol, an oxidant, a weak acid, or a bactericidal agent and combinations thereof.

7. The coating of claim 1, wherein the at least one non-biological antimicrobial and/or antiviral agent is an alcohol, electrolysed water, hypochlorous acid, a metal oxide, a poloxamer, a quaternary ammonium salt, fluoride ions, chitosan, poly(hexamethylene guanidine) (PHMG), carnosol, alpha-tocopherol, glutaraldehyde, hyaluronic acid, citric acid, acetic acid, and combinations thereof.

8. The coating of claim 1, wherein the polymer carrier is present in the coating in an amount of between about 0.1% and about 20%, optionally between about 8% and about 20%, or in an amount of between about 0.5% and about 5%.

9. The coating of claim 1, wherein the polymer carrier is a water-based, water-soluble polymer, optionally a biodegradable water-based polymer.

10. The coating of claim 1, wherein the polymer carrier is selected from:
Poly(ethylene glycol) (PEG), Polyethylene Oxide (PEO), Polyvinyl pyrrolidone (PVP), Polyvinyl alcohol (PVA), polyvinyl chloride, polyvinylidene fluoride, Polyacrylic acid (PAA), Polyacrylamides, N-(2-Hydroxypropyl) methacrylamide (HPMA), poly(methyl methacrylate) (PMMA), poly (2-phenyl-2-oxazoline) (PPhOx), poly(2-hydroxyethyl methacrylate), poly (1,2butylene glycol) (PBG), polyacrylonitrile, poly Divinyl Ether-Maleic Anhydride, Polyoxazolines, Polyphosphates, Polyphosphazenes, Xanthan Gum, Pectin, Chitosan, Dextran, Carrageenan, Guar Gum, Hydroxypropylmethyl cellulose (HPMC), Hydroxypropyl cellulose (HPC), carboxymethyl cellulose, Hydroxyethyl cellulose (HEC), Sodium carboxy methyl cellulose (Na-CMC), Hyaluronic acid (HA), Albumin, Starch, gum arabic, dextrin glue and combinations thereof.

11. The coating of claim 10, wherein PVA has a molecular weight of between about 1 kDa and 200 kDa, preferably between about 2k Da and 130 kDa.

12. The coating of claim 10, wherein the PVA is cross-linked.

13. The coating of claim 1, wherein the polymer carrier is water insoluble or is a solvent-based polymer.

14. The coating of claim 13, wherein the polymer carrier is selected from a derivative of cellulose including ethyl cellulose, methyl cellulose, carboxymethyl cellulose, cellulose acetate and cellulose acetate butyrate, and combinations thereof.

15. The coating of claim 1, wherein the polymer carrier has adhesive properties.

16. The coating of claim 1, wherein the coating further includes a plasticiser or wherein the polymer carrier is a plasticiser or has properties of a plasticiser.

17. The coating of claim 16, wherein the plasticiser is selected from: glycerol, sorbitol, sucrose, dibutyl phthalate, ethylene glycol, diethylene glycol, tri ethylene glycol, tetra ethylene glycol, polyethylene glycol, oleic acid, citric acid, tartaric acid, malic acid, Soybean oil, Dodecanol, lauric acid, tributyrin, trilaurin, epoxidized soybean oil, mannitol, diethanolamine, Fatty acids, triethyl citrate, and/or sucrose esters, and combinations thereof.

18. The coating of claim 1, wherein the coating is formulated as nanofibres.

19. The coating of claim 1, wherein the coating is formulated as a spray, dip or as a paint.

20. The coating of claim 1, wherein the coating further includes a neutral, pleasant, or unpleasant fragrance and/or flavouring, and/or colourant.

21. The coating of claim 1, wherein the coating further includes nitrile, calcium carbonate, calcium nitrate tetrahydrate, calcium chloride, water, one or more solvent, and combinations and mixtures thereof.

22-29. (canceled)
